(19) United States
(12) Patent Application Publication
(10) Pub. No.: US 2025/0048455 A1
(43) Pub. Date: Feb. 6, 2025

(54) FAST LINK RECOVERY FOR NON-TERRESTRIAL NETWORK DISTRIBUTED UNIT PROCESSED ARCHITECTURE

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Prasad Reddy KADIRI, San Diego, CA (US); Anand PALANIGOUNDER, San Diego, CA (US)

(21) Appl. No.: 18/362,784

(22) Filed: Jul. 31, 2023

(51) Int. Cl. H04W 76/10; H04W 12/06; H04W 36/30

(52) U.S. Cl. CPC H04W 76/10; H04W 12/06; H04W 36/305; H04W 84/06

(57) ABSTRACT

The apparatus may be a wireless device configured to receive a set of security parameters associated with one of a layer 1 (L1) link reestablishment procedure or a layer 2 (L2) link reestablishment procedure, detect a failure of a radio link at the wireless device. The apparatus may further be configured to transmit, for a network node, at least one of an L1 link recovery request or an L2 link recovery request, including an authentication value based on the set of security parameters, and receive, based on at least one of the L1 link recovery request or the L2 link recovery request, a link recovery message.

### TECHNICAL FIELD

The present disclosure relates generally to communication systems, and more particularly, to link recovery associated with non-terrestrial networks (NTN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) or component configured to receive a set of security parameters associated with one of a layer 1 (L1) link reestablishment procedure or a layer 2 (L2) link reestablishment procedure, detect a failure of a radio link at the wireless device. The apparatus may further be configured to transmit, for a network node, at least one of an L1 link recovery request or an L2 link recovery request, where at least one of the L1 link recovery request or the L2 link recovery request includes an authentication value based on the set of security parameters, and receive, based on at least one of the L1 link recovery request or the L2 link recovery request, a link recovery message.

In an aspect of the disclosure, a method, a computer-readable medium, and an apparatus are provided. The apparatus may be a network node or network device such as a base station or component (e.g., a satellite-based distributed unit (DU)) configured to transmit, for a wireless device, a set of security parameters associated with one of an L1 link reestablishment procedure or an L2 link reestablishment procedure. The apparatus may further be configured to receive, from the wireless device experiencing a failure of a first radio link, at least one of an L1 link recovery request or an L2 link recovery request, where at least one the L1 link recovery request or the L2 link recovery request includes an authentication value based on the set of security parameters, and transmit, for the wireless device, a link recovery message associated with a reestablishment of a second radio link.

In an aspect of the disclosure, a method, a computer-readable medium, and an apparatus are provided. The apparatus may be a network entity such as a central or centralized unit (CU) or CU component configured to output, for a network node, at least one of one or more indications of values associated with a set of security parameters associated with one of an L1 link reestablishment procedure or an L2 link reestablishment procedure or the set of security parameters and output, for a wireless device, the set of security parameters associated with one of the L1 link reestablishment procedure or the L2 link reestablishment procedure.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a diagram illustrating an example environment that may support wireless communication including aspects of a terrestrial network (TN) and NTN, as presented herein.

FIG. 5A illustrates an example network architecture capable of supporting NTN access, e.g., using 4G NR, as presented herein.

FIG. 5B shows a diagram of a network architecture capable of supporting NTN access, e.g., using 4G NR, as presented herein.

FIG. 5C shows a diagram of a network architecture capable of supporting NTN access, e.g., using 5G NR, as presented herein.

FIG. 6 is a diagram illustrating a set of components of a wireless network (e.g., a TN or an NTN that may be configured to participate and/or implement a fast link recovery procedure in accordance with some aspects of the disclosure.

FIG. 7 is a call flow diagram illustrating a fast link recovery procedure in accordance with some aspects of the disclosure.

FIG. 8A is a diagram, illustrating a set of operations and/or calculations that may be associated with a message authentication code for integrity (MAC-I) value.

FIG. 8B is a diagram illustrating information that may be provided to a UE in association with establishing a connection with the first cell associated with the first DU in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

### DETAILED DESCRIPTION

In some aspects of wireless communication, a cell associated with an NTN cell (e.g., associated with a satellite-based base station and/or DU) may cover a (very) wide area and may be easily blocked, e.g., by buildings, tunnels, or other obstacles. Based on the wide coverage that is easily blocked, even if the UE temporarily loses contact with an NTN cell serving the UE, it may be likely that the UE will identify the same NTN cell again after passing through a blocked area. In some aspects, the UE may initiate a radio resource control (RRC) reestablishment procedure to connect to the same NTN cell. Because the RRC reestablishment procedure, in some aspects, includes RRC-level interaction (e.g., layer 3 (L3) communication) between the UE and a CU via the satellite-based base station and/or DU, the reestablishment procedure may involve long delays associated with transmissions to and from the satellite-based base station and/or DU. For example, the reestablishment procedure may, due to a radio link control (RLC) flush (e.g., a reset of RLC state or a reset of RLC parameters associated with the RLC state), involve control plane signaling and user plane retransmissions associated with a packet data convergence protocol (PDCP).

Various aspects relate generally to a novel link reestablishment for reestablishing a link with a same DU or, in some aspects, for establishing a link with a DU associated with a same CU that avoids resetting layer 3 parameters. Additionally, or alternatively, in some aspects, neither the PDCP (e.g., a state of the PDCP) or a service data adaptation protocol (SDAP) (e.g., a state of the SDAP) may be affected. For example, neither the PDCP nor the SDAP may be associated with a change in state (e.g., a change in parameters associated with a state of the PDCP or the SDAP) during the reestablishment procedure. The novel link reestablishment procedure, in some aspects, may reduce a link reestablishment time compared to an RRC reestablishment procedure associated with configuring L3 parameters, where the reduction may be larger for NTNs than for terrestrial networks. Some aspects more specifically relate to providing configuration information that may be used to enable a link reestablishment procedure that reconfigures L1 and/or L2 parameters while reusing L3 parameters (e.g., avoids configuring L3 parameters). In some examples, a CU may be configured to output, and a network node may be configured to receive, at least one of one or more indications of values associated with a set of security parameters associated with one of an L1 link reestablishment procedure or an L2 link reestablishment procedure or the set of security parameters (where the L1 and/or L2 link reestablishment, in some aspects, may not involve a change to a state of the PDCP and/or the SDAP). The CU may further be configured to output, for a wireless device, the set of security parameters associated with one of the L1 link reestablishment procedure or the L2 link reestablishment procedure. The set of security parameters, in some aspects, may be output by the CU for the DU to output for the wireless device. Accordingly, in some aspects, the DU may be configured to transmit, and the wireless device may be configured to receive, the set of security parameters associated with one of the L1 link reestablishment procedure or the L2 link reestablishment procedure. The wireless device may be configured to detect a radio link failure. Based on detecting the radio link failure, the wireless device may be configured to transmit, and the DU may be configured to receive, at least one of an L1 link recovery request or an L2 link recovery request. In some aspects, the at least one of the L1 link recovery request or the L2 link recovery request may include an authentication value based on the set of security parameters. In some aspects, the DU may be configured to verify, based on the authentication value, that at least one of the L1 link recovery request or the L2 link recovery request is valid. To verify that the at least one of the L1 link recovery request or the L2 link recovery request is valid, in some aspects, the DU may be configured to determine that the authentication value included in at least one of the L1 link recovery request or the L2 link recovery request matches a locally-stored authentication value. In some aspects, to verify that the at least one of the L1 link recovery request or the L2 link recovery request is valid, the DU may be configured to transmit, and the CU may be configured to receive, a verification request including the authentication value. Based on the verification request, the CU may be configured to output, and the DU may be configured to receive, a verification response verifying that the authentication value is valid. Based on verifying that at least one of the L1 link recovery request or the L2 link recovery request is valid, the DU may be configured to transmit, and the wireless device may be configured to receive, a link recovery message associated with a reestablishment of a second radio link.

Particular aspects of the subject matter described in this disclosure can be implemented to realize one or more of the following potential advantages. In some examples, by using the novel L1 link reestablishment procedure and/or the L2 link reestablishment procedure, the described techniques can be used to reduce a latency associated with link reestablishment and/or recovery, especially associated with an NTN.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

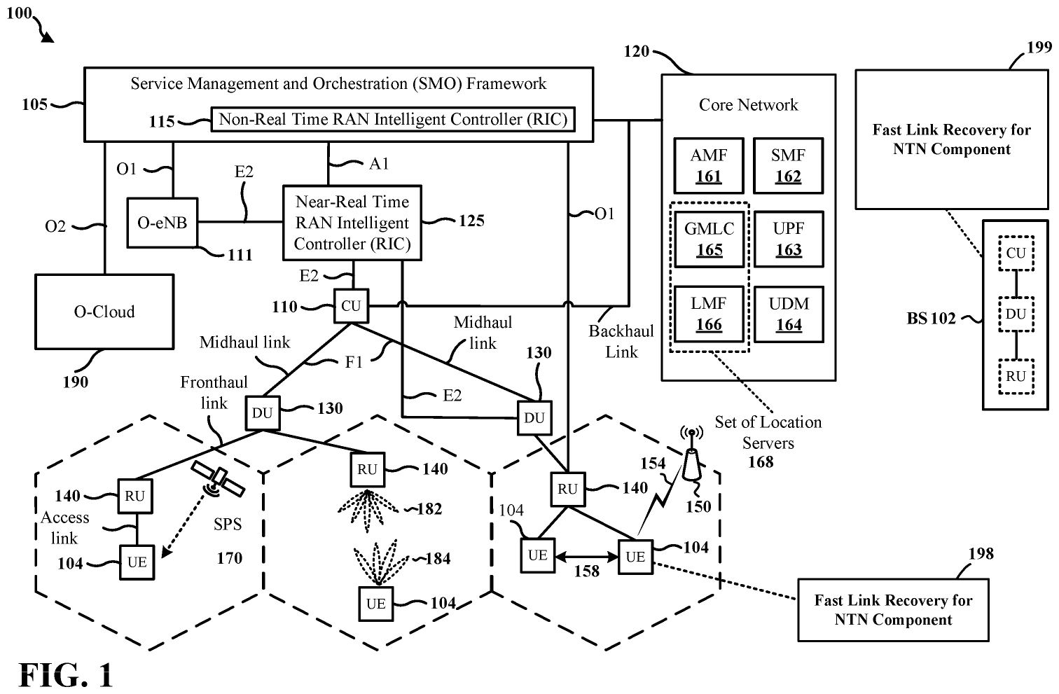

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-124.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a fast link recovery for NTN component 198 that may be configured to receive a set of security parameters associated with one of an L1 link reestablishment procedure or an L2 link reestablishment procedure, detect a failure of a radio link at the wireless device. The fast link recovery for NTN component 198 may further be configured to transmit, for a network node, at least one of an L1 link recovery request or an L2 link recovery request, where at least one of the L1 link recovery request or the L2 link recovery request includes an authentication value based on the set of security parameters, and receive, based on at least one of the L1 link recovery request or the L2 link recovery request, a link recovery message. In certain aspects, the base station 102 (or a DU of the base station) may have a fast link recovery for NTN component 199 that may be configured to transmit, for a wireless device, a set of security parameters associated with one of an L1 link reestablishment procedure or an L2 link reestablishment procedure. The fast link recovery for NTN component 199 may further be configured to receive, from the wireless device experiencing a failure of a first radio link, at least one of an L1 link recovery request or an L2 link recovery request, where at least one the L1 link recovery request or the L2 link recovery request includes an authentication value based on the set of security parameters, and transmit, for the wireless device, a link recovery message associated with a reestablishment of a second radio link. In certain aspects, the base station 102 (or a CU of the base station) may have a fast link recovery for NTN component 199 that may be configured to output, for a network node, at least one of one or more indications of values associated with a set of security parameters associated with one of an L1 link reestablishment procedure or an L2 link reestablishment procedure or the set of security parameters and output, for a wireless device, the set of security parameters associated with one of the L1 link reestablishment procedure or the L2 link reestablishment procedure. While the discussion below may focus on a split DU and CU in an NTN context, the disclosure may be applicable to a split DU and CU in a terrestrial network (TN) context.

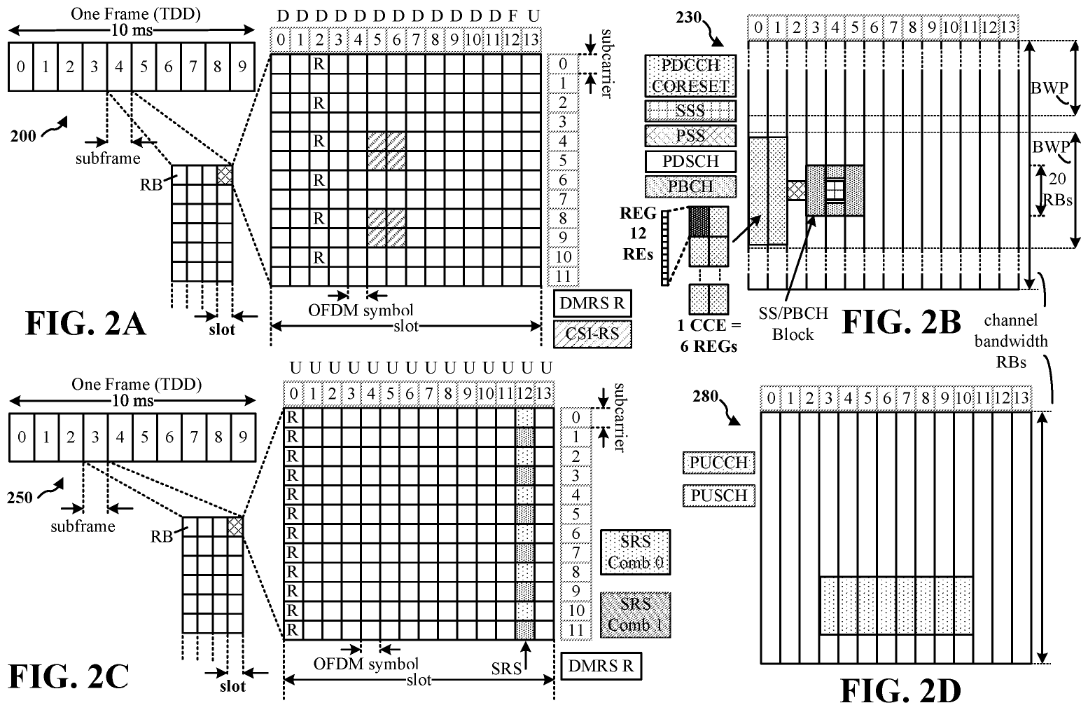

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through RRC signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

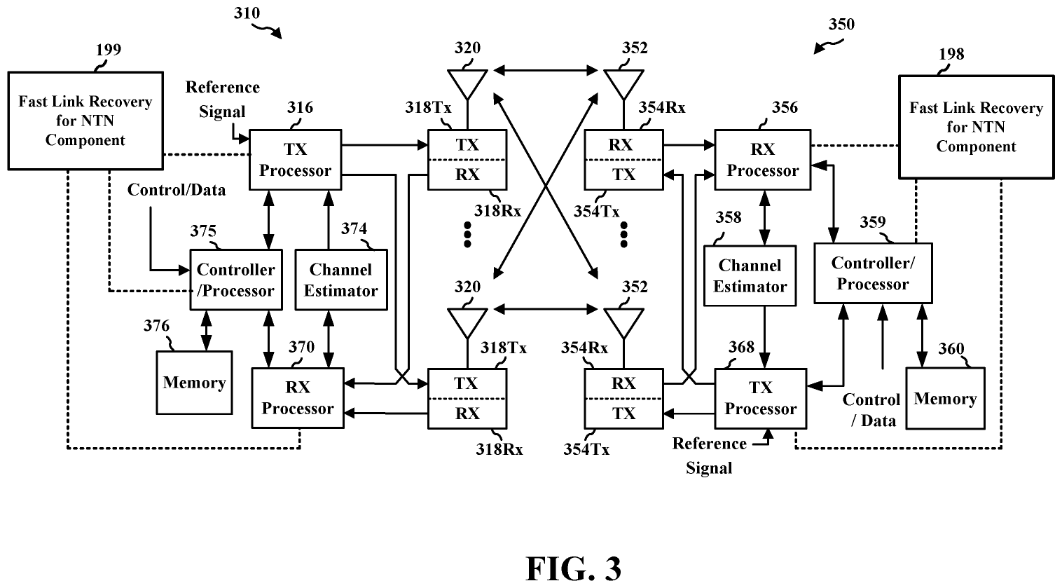

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a PDCP layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the fast link recovery for NTN component 198 of FIG. 1.

At least one of the TX processor 316, the RX processor 370, and the controller/processor 375 may be configured to perform aspects in connection with the fast link recovery for NTN component 199 of FIG. 1.

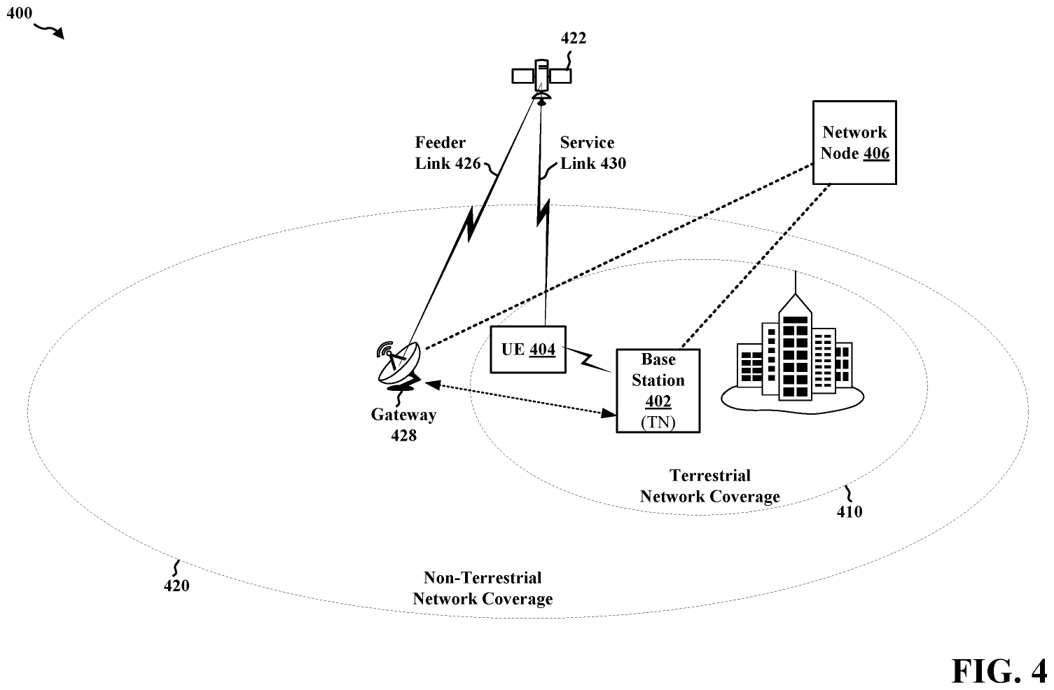

FIG. 4 is a diagram illustrating an example environment 400 that may support wireless communication including aspects of a TN and NTN, as presented herein. To enable communication with a UE, a number of approaches may be utilized.

In some examples, a UE may communicate with a terrestrial network. In the illustrated example of FIG. 4, a TN includes a base station 402 that provides coverage to UEs, such as an example UE 404, located within a coverage area 410 for the TN. The base station 402 may facilitate communication between the UE 404 and a network node 406. Aspects of the network node 406 may be implemented by a core network, such as the example core network 120 of FIG. 1.

In some examples, a UE may transmit or receive communication via an NTN. As an example, the UE may transmit or receive satellite-based communication (e.g., via an Iridium-like satellite communication system or a satellite-based 3GPP NTN). For example, an aerial device 422 may provide coverage to one or more UEs, such as an example UE 404, located within a coverage area 420 for the aerial device 422. In some examples, the aerial device 422 may communicate with the network node 406 through a feeder link 426 established between the aerial device 422 and a gateway 428 in order to provide service to the UE 404 within the coverage area 420 of the aerial device 422 via a service link 430. The UE 404 may be within the coverage area 420 and the coverage area 410. The feeder link 426 may include a wireless link between the aerial device 422 and the gateway 428. The service link 430 may include a wireless link between the aerial device 422 and the UE 404. In some examples, the gateway 428 may communicate directly with the network node 406. In some examples, the gateway 428 may communicate with the network node 406 via the base station 402.

In some aspects, the aerial device 422 may be configured to communicate directly with the gateway 428 via the feeder link 426. The feeder link 426 may include a radio link that provides wireless communication between the aerial device 422 and the gateway 428.

In some aspects, the aerial device 422 may communicate with the gateway 428 via one or more other aerial devices. For example, the aerial device 422 and a second aerial device (not shown) may be part of a constellation of satellites (e.g., aerial devices) that communicate via inter-satellite links (ISLs). For example, the aerial device 422 may establish an ISL with the second aerial device. The ISL may be a radio interface or an optical interface and operate in the RF frequency or optical bands, respectively. The second aerial device may communicate with the gateway 428 via a second feeder link, similarly as the aerial device 422 communicates with the gateway 428.

In some examples, the aerial device 422 and/or the second aerial device may include an aerial device, such as, but not limited to, an unmanned aircraft system (UAS), a balloon, a drone, an unmanned aerial vehicle (UAV), or the like. Examples of a UAS platform that may be used for NTN communication include systems including Tethered UAS (TUAS), Lighter Than Air UAS (LTA), Heavier Than Air UAS (HTA), and High Altitude Platforms (HAPs). In some examples, the aerial device 422 and/or the second aerial device may include a satellite or a space-borne vehicle placed into Low-Earth Orbit (LEO), Medium-Earth Orbit (MEO), Geostationary Earth Orbit (GEO), or High Elliptical Orbit (HEO).

In some aspects, the aerial device 422 and/or the second aerial device may implement a transparent payload (sometimes referred to as a “bent pipe” payload). For example, after receiving a signal, a transparent aerial device may have the ability to change the frequency carrier of the signal, perform RF filtering on the signal, and amplify the signal before outputting the signal. In such aspects, the signal output by the transparent aerial device may be a repeated signal in which the waveform of the output signal is unchanged relative to the received signal.

In other aspects, the aerial device 422 and/or the second aerial device may implement a regenerative payload (e.g., associated with a DU). For example, a regenerative aerial device may have the ability to perform all of, or part of, the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In examples in which the aerial device implements a transparent payload, the transparent aerial device may communicate with the base station 402 via the gateway 428. In some such examples, the base station 402 may facilitate communication between the gateway 428 and the network node 406. In examples in which the aerial device implements a regenerative payload, the regenerative aerial device may have an on-board base station. In some such examples, the on-board base station may communicate with the network node 406 via the gateway 428. In some examples, the on-board base station may include a DU and a CU, such as the DU 130 and the CU 110 of FIG. 1. In some examples, the on-board base station may include a DU that is in communication with a corresponding CU that is on the ground.

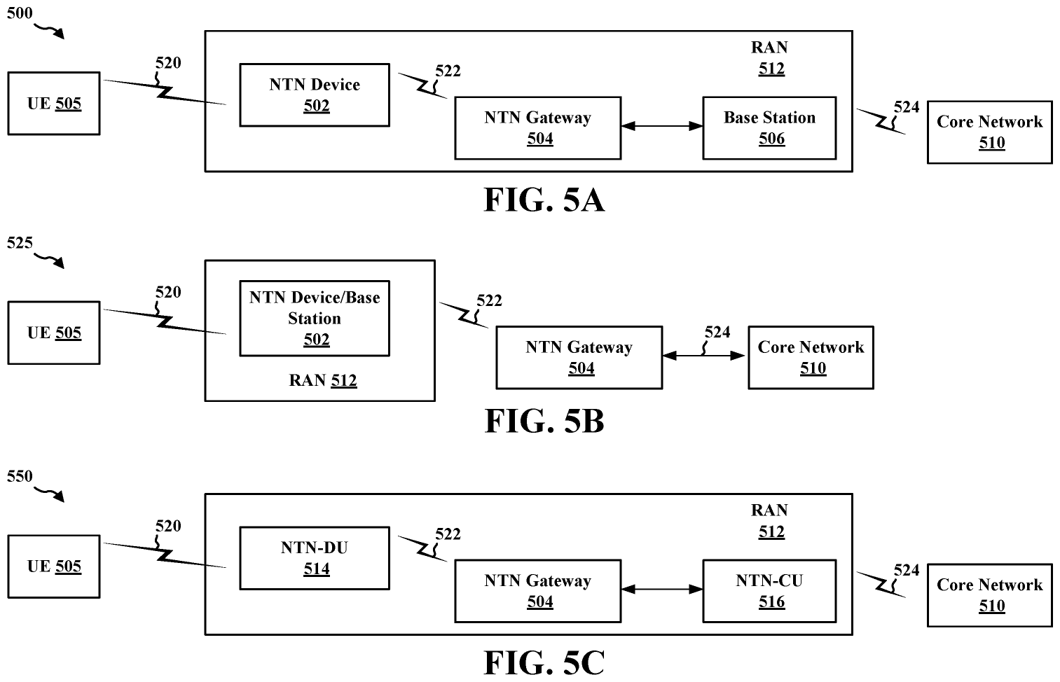

FIG. 5A illustrates an example network architecture 500 capable of supporting NTN access, e.g., using 4G NR, as presented herein. Although the aspects are described using the example of 4G NR, the concepts presented herein may also be applied for other types of core networks. FIG. 5A illustrates a network architecture with transparent payloads. While aspects of FIG. 5A illustrate a 4G-based network, similar network implementations and configurations may be used for other communication technologies, such as 3G, 4G LTE, 5G, etc.

The network architecture 500 of FIG. 5A includes a UE 505, an NTN device 502, an NTN gateway 504 (sometimes referred to as “gateways,” “earth stations,” or “ground stations”), and a base station 506 having the capability to communicate with the UE 505 via the NTN device 502. The NTN device 502, the NTN gateway 504, and the base station 506 may be part of a RAN 512 (e.g., an NG RAN).

The base station 506 may be a network node that corresponds to the network node 406 of FIG. 4. The network architecture 500 is illustrated as further including a core network 510. In some aspects, the core network 510 may include a number of Fifth Generation (5G) networks including 5G Core Networks (5GCNs) and may correspond to the core network 120 described in connection with FIG. 1. The core network 510 may be public land mobile networks (PLMN). In some aspects, the core network may be 4GCNs.

Permitted connections in the network architecture 500 with transparent payloads illustrated in FIG. 5A, allow the base station 506 to access the NTN gateway 504 and the core network 510. In some examples, the base station 506 may be shared by multiple PLMNs. Similarly, the NTN gateway 504 may be shared by more than one base station.

FIG. 5A provides a generalized illustration of various components, any or all of which may be utilized as appropriate, and each of which may be duplicated or omitted, as necessary. Specifically, although the example of FIG. 5A includes UE 505, it should be understood that many UEs (e.g., hundreds, thousands, millions, etc.) may utilize the network architecture 500. Similarly, the network architecture 500 may include a larger (or smaller) number of NTN devices, NTN gateways, base stations, RAN, core networks, and/or other components. The illustrated connections that connect the various components in the network architecture 500 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 505 is configured to communicate with the core network 510 via the NTN device 502, the NTN gateway 504, and the base station 506. As illustrated by the RAN 512, one or more RANs associated with the core network 510 may include one or more base stations. Access to the network may be provided to the UE 505 via wireless communication between the UE 505 and the base station 506 (e.g., a serving base station), via the NTN device 502 and the NTN gateway 504. The base station 506 may provide wireless communications access to the core network 510 on behalf of the UE 505, e.g., using 4G NR.

The base station 506 may be referred to by other names such as a gNB, a “satellite node,” a satellite NodeB (sNB), “satellite access node,” etc. The base station 506 may not be the same as terrestrial network gNBs, but may be based on a terrestrial network gNB with additional capability. For example, the base station 506 may terminate the radio interface and associated radio interface protocols to the UE 505 and may transmit DL signals to the UE 505 and receive UL signals from the UE 505 via the NTN device 502 and the NTN gateway 504. The base station 506 may also support signaling connections and voice and data bearers to the UE 505 and may support handover of the UE 505 between different radio cells for the NTN device 502, between different NTN devices and/or between different base stations. The base station 506 may be configured to manage moving radio beams (e.g., for airborne vehicles and/or non-geostationary (non-GEO) devices) and associated mobility of the UE 505. The base station 506 may assist in the handover (or transfer) of the NTN device 502 between different NTN gateways or different base stations. In some examples, the base station 506 may be separate from the NTN gateway 504, e.g., as illustrated in the example of FIG. 5A. In other examples, the base station 506 may include or may be combined with one or more NTN gateways, e.g., using a split architecture. For example, with a split architecture, the base station 506 may include a CU, such as the example CU 110 of FIG. 1, and the NTN gateway 504 may include or act as DU, such as the example DU 130 of FIG. 1. The base station 506 may be fixed on the ground with transparent payload operation. In one implementation, the base station 506 may be physically combined with, or physically connected to, the NTN gateway 504 to reduce complexity and cost.

The NTN gateway 504 may be shared by more than one base station and may communicate with the UE 505 via the NTN device 502. The NTN gateway 504 may be dedicated to one associated constellation of NTN devices. The NTN gateway 504 may be included within the base station 506, e.g., as a base station-DU within the base station 506. The NTN gateway 504 may communicate with the NTN device 502 using control and user plane protocols. The control and user plane protocols between the NTN gateway 504 and the NTN device 502 may: (i) establish and release the NTN gateway 504 to the NTN device 502 communication links, including authentication and ciphering; (ii) update NTN device software and firmware; (iii) perform NTN device Operations and Maintenance (O&M); (iv) control radio beams (e.g., direction, power, on/off status) and mapping between radio beams and NTN gateway UL and DL payload; and/or (v) assist with handoff of the NTN device 502 or radio cell to another NTN gateway.

Support of transparent payloads with the network architecture 500 shown in FIG. 5A may impact the communication system as follows. The core network 510 may treat a satellite RAT as a new type of RAT with longer delay, reduced bandwidth and/or higher error rate. Consequently, there may be some impact to PDU session establishment and mobility management (MM) and connection management (CM) procedures. The NTN device 502 may be shared with other services (e.g., satellite television, fixed Internet access) with 4G NR mobile access for UEs added in a transparent manner. This may enable legacy NTN devices to be used and may avoid the need to deploy a new type of NTN device. The base station 506 may assist assignment and transfer of the NTN device 502 and radio cells between the base station 506 and the NTN gateway 504 and support handover of the UE 505 between radio cells, NTN devices, and other base stations. Thus, the base station 506 may differ from a terrestrial network gNB. Additionally, a coverage area of the base station 506 may be much larger than the coverage area of a terrestrial network base station.

In the illustrated example of FIG. 5A, a service link 520 may facilitate communication between the UE 505 and the NTN device 502, a feeder link 522 may facilitate communication between the NTN device 502 and the NTN gateway 504, and an interface 524 may facilitate communication between the base station 506 and the core network 510. The service link 520 and the feeder link 522 may be implemented by a same radio interface (e.g., the NR-Uu interface). The interface 524 may be implemented by the NG interface.

FIG. 5B shows a diagram of a network architecture 525 capable of supporting NTN access, e.g., using 4G NR, as presented herein. The network architecture 525 shown in FIG. 5B is similar to that shown in FIG. 5A, like designated elements being similar or the same. FIG. 5B, however, illustrates a network architecture with regenerative payloads, as opposed to transparent payloads shown in FIG. 5A. A regenerative payload, unlike a transparent payload, includes an on-board base station (e.g., includes the functional capability of a base station), and is referred to herein as an NTN device 502/base station. The on-board base station may be a network node that corresponds to the base station 402 or the network node 406 in FIG. 4. The RAN 512 is illustrated as including the NTN device 502/base station. Reference to the NTN device 502/base station may refer to functions related to communication with the UE 505 and the core network 510 and/or to functions related to communication with the NTN gateway 504 and with the UE 505 at a physical radio frequency level.

An on-board base station may perform many of the same functions as the base station 506 as described previously. For example, the NTN device 502/base station may terminate the radio interface and associated radio interface protocols to the UE 505 and may transmit DL signals to the UE 505 and receive UL signals from the UE 505, which may include encoding and modulation of transmitted signals and demodulation and decoding of received signals. The NTN device 502/base station may also support signaling connections and voice and data bearers to the UE 505 and may support handover of the UE 505 between different radio cells for the NTN device 502/base station and between or among different NTN device/base stations. The NTN device 502/base station may assist in the handover (or transfer) of the UE 505 between different NTN gateways and different control networks. The NTN device 502/base station may hide or obscure specific aspects of the NTN device 502/base station from the core network 510, e.g., by interfacing to the core network 510 in the same way or in a similar way to a terrestrial network base station. The NTN device 502/base station may further assist in sharing of the NTN device 502/base station. The NTN device 502/base station may communicate with one or more NTN gateways and with one or more core networks via the NTN gateway 504. In some aspects, the NTN device 502/base station may communicate directly with other NTN device/base stations using Inter-Satellite Links (ISLs), which may support an Xn interface between any pair of NTN device/base stations.

With low Earth orbit (LEO) devices, the NTN device 502/base station may manage moving radio cells with coverage at different times. The NTN gateway 504 may be connected directly to the core network 510, as illustrated. The NTN gateway 504 may be shared by multiple core networks, for example, if NTN gateways are limited. In some examples the core network 510 may be aware of coverage area(s) of the NTN device 502/base station in order to page the UE 505 and to manage handover. Thus, as can be seen, the network architecture 525 with regenerative payloads may have more impact and complexity with respect to both the NTN device 502/base station and the core network 510 than the network architecture 500 including transparent payloads, as shown in FIG. 5A.

Support of regenerative payloads with the network architecture 525 shown in FIG. 5B may impact the network architecture 525 as follows. The core network 510 may be impacted if fixed tracking areas and fixed cells are not supported, because core components of mobility management and regulatory services, which are based on fixed cells and fixed tracking areas for terrestrial PLMNs, may be replaced by a new system (e.g., based on a location of the UE 505). If fixed tracking areas and fixed cells are supported, the core network 510 may map any fixed tracking area to one or more NTN device/base stations with current radio coverage of the fixed tracking area when performing paging of the UE 505 that is located in this fixed tracking area. This could include configuration in the core network 510 of long term orbital data for the NTN device 502/base station (e.g., obtained from an operator of the NTN device 502/base station) and could add significant new impact to core network 510.

In the illustrated example of FIG. 5B, a service link 520 may facilitate communication between the UE 505 and the NTN device 502/base station, a feeder link 522 may facilitate communication between the NTN device 502/base station and the NTN gateway 504, and an interface 524 may facilitate communication between the NTN gateway 504 and the core network 510. The service link 520 may be implemented by the NR-Uu interface. The feeder link 522 may be implemented by the NG interface over SRI. The interface 524 may be implemented by the NG interface.

FIG. 5C shows a diagram of a network architecture 550 capable of supporting NTN access, e.g., using 5G NR, as presented herein. The network architecture shown in FIG. 5C is similar to that shown in FIGS. 5A and 5B, like designated elements being similar or the same. FIG. 5C, however, illustrates a network architecture with regenerative payloads, as opposed to transparent payloads, as shown in FIG. 5A, and with a split architecture for the base station. For example, the base station may be split between a CU, such as the CU 110 of FIG. 1, and a DU, such as the DU 130 of FIG. 1. In the illustrated example of FIG. 5C, the network architecture 550 includes an NTN-CU 516, which may be a ground-based base station or a terrestrial base station. The regenerative payloads may be associated with an on-board base station DU, and is referred to herein as an NTN-DU 514. The NTN-CU 516 and the NTN-DU 514, collectively or individually, may correspond to the network node 406 associated with the base station 402 in FIG. 4.

The NTN-DU 514 communicates with the NTN-CU 516 via the NTN gateway 504. The NTN-CU 516 together with the NTN-DU 514 perform functions, and may use internal communication protocols, which are similar to, or the same as, a gNB with a split architecture. In the example, the NTN-DU 514 may correspond to and perform functions similar to, or the same as, a gNB Distributed Unit (gNB-DU), while the NTN-CU 516 may correspond to and perform functions similar to, or the same as, a gNB Central Unit (gNB-CU). However, the NTN-CU 516 and the NTN-DU 514 may each include additional capability to support the UE 505 access using NTN devices.

The NTN-DU 514 and the NTN-CU 516 may communicate with one another using an F1 Application Protocol (F1AP), and together may perform some or all of the same functions as the base station 506 or the NTN device 502/base station as described in connection with FIGS. 5B and 5C, respectively.

The NTN-DU 514 may terminate the radio interface and associated lower level radio interface protocols to the UE 505 and may transmit DL signals to the UE 505 and receive UL signals from the UE 505, which may include encoding and modulation of transmitted signals and demodulation and decoding of received signals. The operation of the NTN-DU 514 may be partly controlled by the NTN-CU 516. The NTN-DU 514 may support one or more NR radio cells for the UE 505. The NTN-CU 516 may also be split into separate control plane (CP) (NTN-CU-CP) and user plane (UP) (NTN-CU-UP) portions. The NTN-DU 514 and the NTN-CU 516 may communicate over an F1 interface to (a) support control plane signaling for the UE 505 using IP. Stream Control Transmission Protocol (SCTP) and F1 Application Protocol (F1AP) protocols, and (b) to support user plane data transfer for a UE using IP, User Datagram Protocol (UDP), PDCP, SDAP. GTP-U and NR User Plane Protocol (NRUPP) protocols.

The NTN-CU 516 may communicate with one or more other NTN-CUs and/or with one more other terrestrial base stations using terrestrial links to support an Xn interface between any pair of NTN-CUs and/or between the NTN-CU 516 and any terrestrial base station.

The NTN-DU 514 together with the NTN-CU 516 may: (i) support signaling connections and voice and data bearers to the UE 505; (ii) support handover of the UE 505 between different radio cells for the NTN-DU 514 and between different NTN-DUs; and (iii) assist in the handover (or transfer) of NTN devices between different NTN gateways or different core networks. The NTN-CU 516 may hide or obscure specific aspects of the NTN devices from the core network 510, e.g., by interfacing to the core network 510 in the same way or in a similar way to a terrestrial network base station.

In the network architecture 550 of FIG. 5C, the NTN-DU 514 that communicates with and is accessible from an NTN-CU may change over time with LEO devices. With the split base station architecture, the core network 510 may connect to NTN-CUs that are fixed and that do not change over time, which may reduce difficulty with paging of the UE 505. For example, the core network 510 may not need to know which NTN-DU should be utilized for paging the UE 505. The network architecture with regenerative payloads with a split base station architecture may thereby reduce the core network 510 impact at the expense of additional impact to the NTN-CU 516.

Support of regenerative payloads with a split base station architecture, as shown in FIG. 5C, may impact the network architecture 550 as follows. The impact to the core network 510 may be limited as for the transparent payloads (e.g., the NTN device 502) discussed above. For example, the core network 510 may treat a satellite RAT in the network architecture 550 as a new type of RAT with longer delay, reduced bandwidth and/or higher error rate. The impact on the NTN-DU 514 may be less than the impact on NTN device/base stations (e.g., the NTN device 502/base station with a non-split architecture), as discussed above in reference to FIG. 5B. The NTN-DU 514 may manage changing association with different (fixed) NTN-CUs. Further, the NTN-DU 514 may manage radio beams and radio cells. The NTN-CU 516 impacts may be similar to the impact of the base station 506 for a network architecture with transparent payloads, as discussed above, except for extra impacts to manage changing associations with different NTN-DUs and reduced impacts to support radio cells and radio beams, which may be transferred to the NTN-DU 514.

In some aspects of wireless communication, a cell associated with an NTN cell (e.g., associated with a satellite-based base station and/or DU) may cover a (very) wide area and may be easily blocked, e.g., by buildings, tunnels, or other obstacles. Based on the wide coverage that is easily blocked, even if the UE temporarily loses contact with an NTN cell serving the UE, it may be likely that the UE will identify the same NTN cell again after passing through a blocked area. In some aspects, the UE may initiate an RRC reestablishment procedure to connect to the same NTN cell. Because the RRC reestablishment procedure, in some aspects, includes RRC-level interaction (e.g., L3 communication) between the UE and a CU via the satellite-based base station and/or DU, the reestablishment procedure may involve long delays associated with transmissions to and from the satellite-based base station and/or DU. For example, the reestablishment procedure may, due to an RLC flush (e.g., a reset of RLC parameters), involve control plane signaling and user plane retransmissions associated with a PDCP due

Various aspects relate generally to a novel link reestablishment for reestablishing a link with a same DU or, in some aspects, for establishing a link with a DU associated with a same CU that avoids resetting L3 parameters. The novel link reestablishment procedure, in some aspects, may reduce a link reestablishment time compared to an RRC reestablishment procedure associated with configuring L3 parameters, where the reduction may be larger for NTNs than for terrestrial networks. Some aspects more specifically relate to providing configuration information that may be used to enable a link reestablishment procedure that avoids configuring L3 parameters. In some examples, a CU may be configured to output, and a network node may be configured to receive, at least one of one or more indications of values associated with a set of security parameters associated with one of an L1 link reestablishment procedure or an L2 link reestablishment procedure or the set of security parameters. The CU may further be configured to output, for a wireless device, the set of security parameters associated with one of the L1 link reestablishment procedure or the L2 link reestablishment procedure. The set of security parameters, in some aspects, may be output by the CU for the DU to output for the wireless device. Accordingly, in some aspects, the DU may be configured to transmit, and the wireless device may be configured to receive, the set of security parameters associated with one of the L1 link reestablishment procedure or the L2 link reestablishment procedure. The wireless device may be configured to detect a radio link failure. Based on detecting the radio link failure, the wireless device may be configured to transmit, and the DU may be configured to receive, at least one of an L1 link recovery request or an L2 link recovery request. In some aspects, the at least one of the L1 link recovery request or the L2 link recovery request may include an authentication value based on the set of security parameters. In some aspects, the DU may be configured to verify, based on the authentication value, that at least one of the L1 link recovery request or the L2 link recovery request is valid. To verify that the at least one of the L1 link recovery request or the L2 link recovery request is valid, in some aspects, the DU may be configured to determine that the authentication value included in at least one of the L1 link recovery request or the L2 link recovery request matches a locally-stored authentication value. In some aspects, to verify that the at least one of the L1 link recovery request or the L2 link recovery request is valid, the DU may be configured to transmit, and the CU may be configured to receive, a verification request including the authentication value. Based on the verification request, the CU may be configured to output, and the DU may be configured to receive, a verification response verifying that the authentication value is valid. Based on verifying that at least one of the L1 link recovery request or the L2 link recovery request is valid, the DU may be configured to transmit, and the wireless device may be configured to receive, a link recovery message associated with a reestablishment of a second radio link.

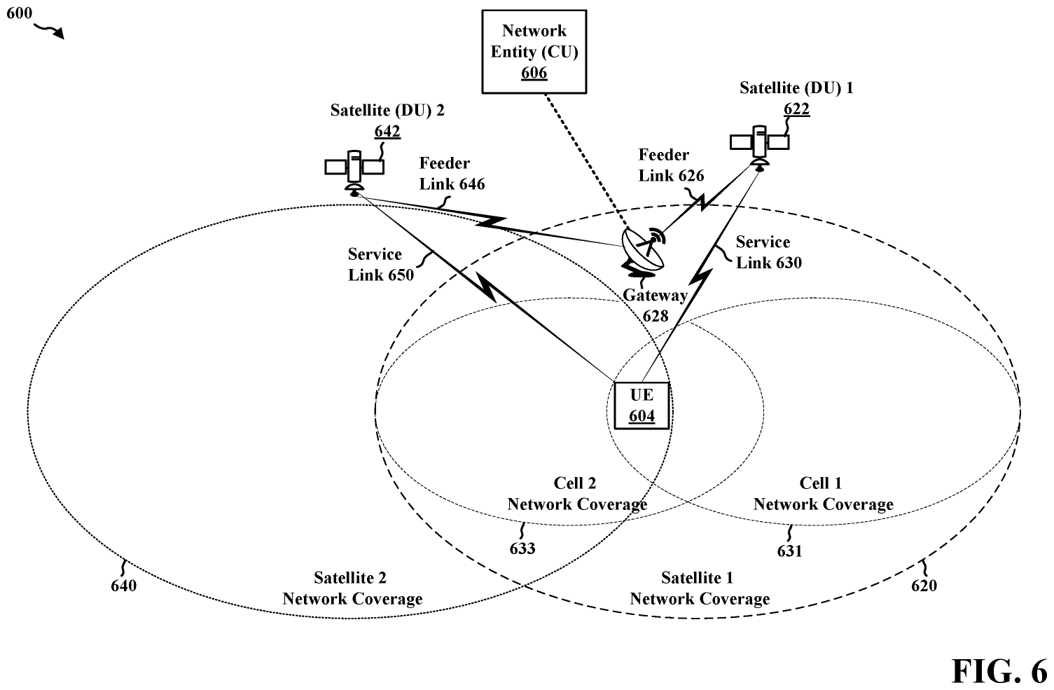

FIG. 6 is a diagram 600 illustrating a set of components of a wireless network (e.g., a TN or an NTN that may be configured to participate and/or implement a fast link recovery procedure (e.g., an L1 link reestablishment procedure and/or an L2 link reestablishment procedure) in accordance with some aspects of the disclosure. For example, a network may include a network entity 606 (e.g., a CU providing access to a core network via a gateway 628), one or more DUs and/or RUs (e.g., a first satellite-based DU 622, a second satellite-based DU 642, or a set of one or more terrestrial DUs and/or RUs (not shown)), and at least one UE (e.g., UE 604). The first satellite-based DU 622 (or a similar DU of a TN) may communicate with the UE 604 via the feeder link 626 and the service link 630 be associated with a network coverage area 620, that may be associated with a plurality of cells (e.g., a first cell with a coverage area 631, a second cell with a coverage area 633, or additional cells (not shown)). The second satellite-based DU 642 (or a similar DU of a similarly-configured TN) may communicate with the UE 604 via the feeder link 646 and the service link 650 in association with a network coverage area 640, that may similarly be associated with a plurality of cells (not shown).

The UE 604, in some aspects, may initially operate in the coverage area 631 associated with a first cell and connect, via a first radio link, to the first cell associated with the first satellite-based DU 622 (or similar terrestrial DU). Based on a change to the environment (e.g., a movement of any of the UE 604, the first satellite-based DU 622, or one or more intervening objects), the first radio link may fail and the UE 604 may identify a cell for reestablishing a radio link to the network. The identified cell, in some aspects, may be based on one or more characteristics of the identified cells and other candidate cells and may be one of the first cell, the second cell, or an additional cell associated with the first satellite-based DU 622 or the second satellite-based DU 642 (or one of a set of cells associated with one or more RUs and/or DUs associated with a same CU of a similarly-configured TN or a network including both terrestrial and non-terrestrial components). The fast link recovery procedure (e.g., the L1 link reestablishment procedure and/or the L2 link reestablishment procedure) may then be used to more quickly reestablish a connection with the identified cell (and ultimately with the network entity 606 (e.g., a CU associated with the first cell and the identified cell). While FIG. 6 illustrates elements of an NTN for which the fast link recovery procedure may provide more significant latency reduction, the fast link recovery procedure may be implemented in a TN or a mixed NTN/TN network with similar components as described above.

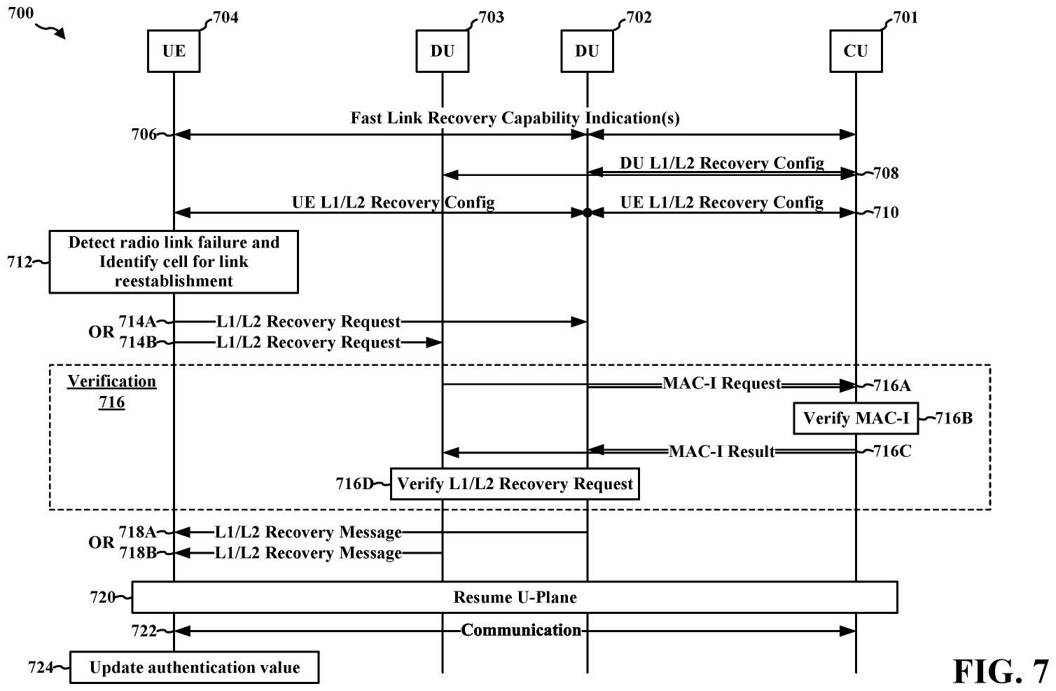

FIG. 7 is a call flow diagram 700 illustrating a fast link recovery procedure in accordance with some aspects of the disclosure. The fast link recovery procedure, in some aspects, may be implemented in an environment as described in relation to FIG. 6. Call flow diagram 700 illustrates a CU 701, a set of DUs including a first DU 702 (e.g., a first satellite-based DU) and a second DU 703 (e.g., a second satellite-based DU), and a UE 704. In some aspects, the first DU 702 and/or the second DU 703 may additionally include an RU and/or perform the functions associated with an RU and, together with the CU 701, may be a component of a disaggregated base station as described in relation to FIG. 1. The functions ascribed to the CU 701, the first DU 702, and/or the second DU 703, in some aspects, may be performed by one or more components of a network entity, a network node, or a network device (a disaggregated network entity/node/device as described above in relation to FIG. 1). Similarly, the functions ascribed to a wireless device such as the UE 704, in some aspects, may be performed by one or more components of a wireless device supporting communication with a network entity/node/device. Accordingly, references to “transmitting” in the description below may be understood to refer to a first component of the network entity, the network node, or the network device (or the wireless device) outputting (or providing) an indication of the content of the transmission to be transmitted by a different component of the network entity, the network node, or the network device (or the wireless device). Similarly, references to “receiving” in the description below may be understood to refer to a first component of the network entity, the network node, or the network device (or the wireless device) receiving a transmitted signal and outputting (or providing) the received signal (or information based on the received signal) to a different component of the network entity, the network node, or the network device (or the wireless device).

In some aspects, the CU 701, the first DU 702, and/or the UE 704 may exchange one or more indications 706 regarding a capability of the UE 704, the first DU 702, and/or the CU 701 to participate in a fast link recovery procedure. For example, the capability may be indicated at a plurality of granularities (e.g., per any unit). For example, the exchange one or more indications 706 may indicate a capability to participate in the fast link recovery procedure per UE (e.g., for a single UE such as UE 704, or for a plurality of UEs), per band, per band combination, per feature set, per RAT, per orbit, per system (TN, NTN), per 3GPP release. Such capability may be updated based on the state of the UE 704, the first DU 702, the second DU 703, and/or the CU 701. Based on a capability of each of the CU 701, the first DU 702, and the UE 704 to participate in (or use) the fast link recovery procedure indicated by the one or more indications 706, the CU 701, in some aspects, may transmit, and the first DU 702 and the second DU 703 may receive, information for the fast link recovery procedure (e.g., DU L1/L2 recovery configuration messages 708). The information for the fast link recovery procedure, in some aspects, may include (1) one or more indications of values associated with a set of security parameters associated with one of an L1 link reestablishment procedure or an L2 link reestablishment procedure or (2) the set of security parameters. In some aspects, the DU L1/L2 recovery configuration messages 708 may include response messages from the first DU 702 and the second DU 703. For example, the information for, or associated with, the fast link recovery procedure, in some aspects, may include one or more of an ID of the UE 704 such as a cell radio network temporary ID (C-RNTI) (e.g., assigned by a PCell associated with the DU L1/L2 recovery configuration messages 708), a tunnel endpoint ID (TEID), a source PCI, a satellite ID (or other data, e.g., an ephemeris, for identifying a satellite), at least one value used for a calculation of an authentication value, a security algorithm associated with at least one of the L1 link reestablishment procedure or the L2 link reestablishment procedure, L2 security parameters, or a duration for which the set of security parameters is valid.

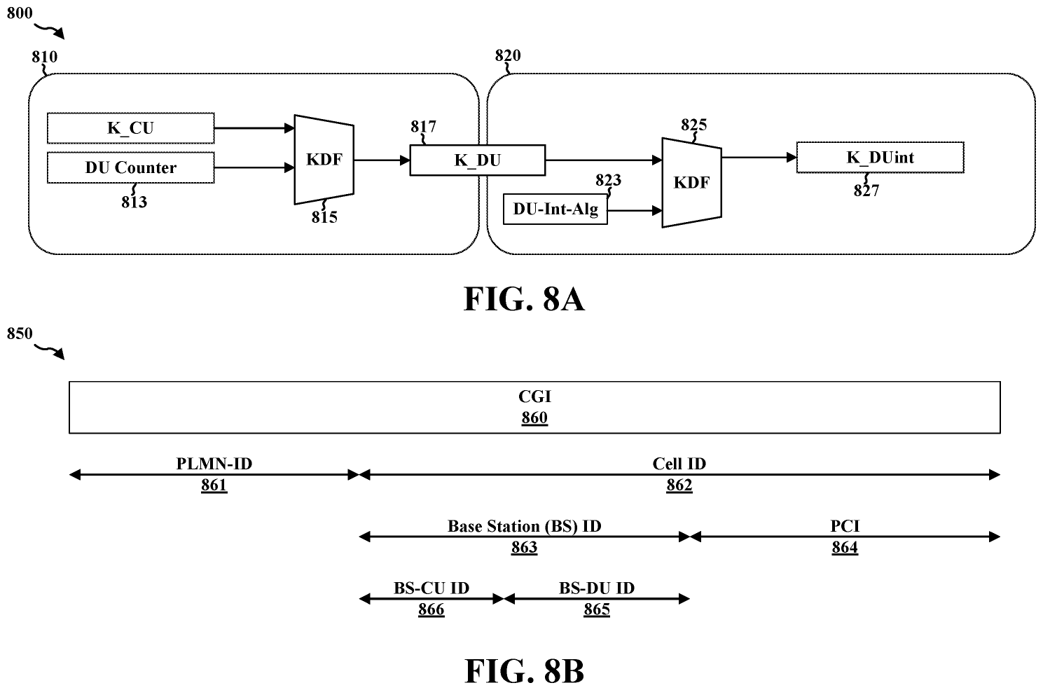

In some aspects, the information for the fast link recovery procedure included in the DU L1/L2 recovery configuration messages 708, in some aspects, may relate to a MAC-I value used for the fast link recovery procedure. FIG. 8A is a diagram 800, illustrating a set of operations and/or calculations that may be associated with a MAC-I value. For example, at least one of (1) the at least one value used for a calculation of an authentication value, (2) the security algorithm associated with at least one of the L1 link reestablishment procedure or the L2 link reestablishment procedure, or (3) the L2 security parameters may include a first value (e.g., a first key value associated with the DU (e.g., K_{DU} 817)) that is produced by an operation and/or calculation 810 that may be performed by the CU 701 (e.g., based on an additional value such as a DU counter 813 and a key derivation function (KDF) 815). The CU 701 may further provide an indication of an integrity algorithm (e.g., DU-Int-Alg 823) to use to generate a second value (e.g., a second key value (e.g., K_{DUInt} 827)) at the first DU 702 (and the second DU 703). Generating the second value, e.g., K_{DUInt} 827, in some aspects, may be associated with an operation and/or calculation 820 include using a KDF 825 based on the K_{DU} 817 and the DU-Int-Alg 823. In some aspects, the CU 701 may calculate and provide a MAC-I value to the first DU 702 and the second DU 703 in the DU L1/L2 recovery configuration messages 708.

In some aspects, the CU 701 may transmit, and the UE 704 may receive (e.g., via the first DU 702), information for the fast link recovery procedure (e.g., UE L1/L2 recovery configuration messages 710). The information for the fast link recovery procedure, in some aspects, may include a set of security parameters associated with at least one of an L1 link reestablishment procedure or an L2 link reestablishment procedure. In some aspects, the UE L1/L2 recovery configuration messages 710 may include response messages from the UE 704. For example, the information for, or associated with, the fast link recovery procedure, in some aspects, may include one or more of an ID of the UE 704, a cell radio network temporary ID (C-RNTI) (e.g., assigned by a PCell associated with the UE L1/L2 recovery configuration messages 710), a tunnel endpoint ID (TEID), a source PCI, at least one value (or algorithm) used for a calculation of an authentication value, a security algorithm associated with at least one of the L1 link reestablishment procedure or the L2 link reestablishment procedure, L2 security parameters (e.g., a MAC-I), or a duration for which the set of security parameters is valid. In some aspects, the UE L1/L2 recovery configuration messages 710 or other configuration messages may include a DU ID via one of system information or dedicated signaling. The DU ID, in some aspects, may be provided either explicitly or implicitly. For example, for explicit indication, the identity value can be included. For implicit indication, the UE 704 may receive position information including a DU ID as described below in relation to FIG. 8B below. In some aspects, the DU ID may be included in a transmission from a DU (e.g., the first DU 702 or the second DU 703) to the CU 701 when an F1 connection is configured and/or setup. The UE L1/L2 recovery configuration messages 710, in some aspects, may include a list of cells for which the UE can perform the fast link recovery procedure (e.g., an L1/L2 link reestablishment/recovery procedure). In some aspects, the DU L1/L2 recovery configuration messages 708 and the UE L1/L2 recovery configuration messages 710 may be associated with establishing a connection with a first cell associated with the first DU 702.

FIG. 8B is a diagram 850 illustrating information that may be provided to the UE 704 in association with establishing a connection with the first cell associated with the first DU 702 in accordance with some aspects of the disclosure. In some aspects, the CU 701 and/or the first DU 702 may transmit a cell global identity (CGI), e.g., CGI 860. The CGI 860, in some aspects, may include a PLMN ID 861 and a cell ID 862. The cell ID 862, in some aspects, may include a base station ID 863 (or BS ID) and a PCI 864. In some aspects, the CGI 860 (and/or the base station ID 863) may include a first set of bits (BS-DU ID 865) used to identify a particular DU (or satellite for an NTN) such as the first DU 702 (or a first satellite associated with the first DU 702). The CGI 860 (and/or the base station ID 863) may additionally, or alternatively, include a second set of bits (BS-CU ID 866) used to identify a particular CU such as the CU 701. The first or second set of bits may, in some aspects, may be indicated based on one or more of a bitmap, mask, and/or start position and length. Accordingly, for a DU associated with a plurality of cells, while the cell ID 862 may different for each cell, the BS-DU ID 865 may be the same. Similarly, for a CU associated with a plurality of DUs (e.g., satellite-based DUs) and a related plurality of cells, while the cell ID 862 (e.g., the BS-DU ID 865, PCI 864, or other bits) may different for each of the plurality of DUs and/or cells, the BS-CU ID 866 may be the same. A UE, such as UE 704, may then use the BS-DU ID 865 and/or the BS-CU ID 866 (e.g., a known set of bits corresponding to a DU ID and/or CU ID) to determine whether (and/or to identify that) a DU and/or CU associated with a failed radio link is a same DU and/or CU associated with a new cell even if the cell ID is different.

The UE 704, at 712, may detect (and identify a reason for) a radio link failure and identify a (new) cell for a link reestablishment. The cell, in some aspects, may be the same (first) cell, a different cell associated with the first DU 702, or a cell associated with the second DU 703. As part of identifying the cell for the link reestablishment at 712, the UE 704 may determine that the new cell (e.g., the new cell identified at 712) is configured to use the fast link recovery procedure (e.g., is associated with the CU 701, the first DU 702, a satellite associated with the first DU 702, etc.). Based on the determination that the new cell is configured to use the fast link recovery procedure, the UE 704 may transmit, and the first DU 702 or the second DU 703 may receive, respectively, one of an L1/L2 recovery request 714A or an L1/L2 recovery request 714B (e.g., at least one of an L1 recovery request or an L2 recovery request) associated with the fast link recovery procedure.

The L1/L2 recovery request 714A or the L1/L2 recovery request 714B, in some aspects, may include an authentication value (e.g., a MAC-I value). In some aspects, the L1/L2 recovery request 714A or the L1/L2 recovery request 714B may include one or more of the ID of the UE 704, the C-RNTI, the TEID, the MAC-I value, a cause value indicating a type of failure associated with the failure of the radio link (e.g., T310 expiry, RACH failure, RLC failure, handover (HO) failure, etc.), an ID of a network node (e.g., the first DU 702 or the second DU 703 associated with at least one of the first radio link or the new cell), or an ID of a network entity (e.g., the CU 701) associated with the network node. In some aspects, the L1/L2 recovery request 714A or the L1/L2 recovery request 714B may be sent with a logical channel ID (LCID) that may be associated with (or identify the L1/L2 recovery request 714A or the L1/L2 recovery request 714B as being associated with) the fast link recovery procedure. In some aspects, the L1/L2 recovery request 714A or the L1/L2 recovery request 714B may sent with a RNTI that may be associated with (or identify the L1/L2 recovery request 714A or the L1/L2 recovery request 714B as being associated with) the fast link recovery procedure. In some aspects, the L1/L2 recovery request 714A or the L1/L2 recovery request 714B may trigger transmission of specific resources such as PRACH that may be associated with (or identify the L1/L2 recovery request 714A or the L1/L2 recovery request 714B as being associated with) the fast link recovery procedure.

To improve the security of the fast link recovery procedure, in some aspects, the authentication value (e.g., the MAC-I value) may be configured to be different for different L1/L2 recovery requests. In some aspects, the authentication value may be calculated based on one or more of a security key (or security key related parameter, e.g., a DU counter provided to, or known at, a DU and a UE related to the fast link recovery procedure), and/or data stream-specific information (e.g., a COUNT value, a BEARER value, and/or a DIRECTION value) for each L1/L2 recovery request (e.g., the L1/L2 recovery request 714A or the L1/L2 recovery request 714B). In some aspects, the network, e.g., the CU 701 and/or one of the first DU 702 or the second DU 703, may provide a set of new values (e.g., at least a subset of the information and/or parameters for the fast link recovery procedure) after an L1/L2 recovery request (e.g., as part of resuming the user plane communication at 720 and exchanging, and/or participating in, communication 722) to be used for a subsequent L1/L2 recovery request.

The set of new values and/or parameters, in some aspects, may be maintained in one of more of the CU 701, the first DU 702, and the second DU 703. If the set of new values and/or parameters is maintained at the CU 701, it may provide the first DU 702 and/or the second DU 703, with the new value or calculated MAC-I based on the new value and configure the UE 704 with the set of new values and/or parameters. In some aspects, the UE 704 and the network (e.g., the CU 701, the first DU 702, and the second DU 703) may use a configured (implicit) rule to derive the values used for an L1/L2 recovery request (e.g., the L1/L2 recovery request 714A or the L1/L2 recovery request 714B or for a subsequent L1/L2 recovery request). In some aspects, a first L1/L2 recovery request (e.g., the L1/L2 recovery request 714A or the L1/L2 recovery request 714B) may be based on a set of values (or security parameters) provided in the DU L1/L2 recovery configuration messages 708 and/or the UE L1/L2 recovery configuration messages 710 with subsequent L1/L2 recovery requests based on the configured rules. The configured rule, in some aspects, may (after one or more of a successfully, or unsuccessfully, completed recovery requests) indicate for the UE 704 and at least one associated DU (e.g., the first DU 702 and/or the second DU 703) to change, e.g., to increment, a current value (e.g., a value received by the UE 704 via the UE L1/L2 recovery configuration messages 710 used for the L1/L2 recovery request 714A or the L1/L2 recovery request 714B).

In some aspects, transmitting at least one of the L1 link recovery request or the L2 link recovery request (e.g., the L1/L2 recovery request 714A or the L1/L2 recovery request 714B) may include transmitting at least one of the L1 link recovery request or the L2 link recovery request to the new cell based on the determination that the new cell is associated with the CU or a CU sharing a same set of security parameters as the CU (or, generally, that the fast link recovery procedure is possible and/or enabled for the cell identified at 712). Determining that the fast link recovery procedure is possible for the cell identified at 712 (e.g., that the new cell is associated with the CU 701, the first DU 702, the satellite associated with the first DU 702, or the first cell), in some aspects, may include determining at least one of (1) that the new cell is associated with the CU 701 (e.g., with the second DU 703 as an example of any of a plurality of additional DUs (not shown), associated with the CU 701 or a similar CU sharing and/or using a same set of security parameters), (2) that the new cell is associated with the satellite associated with the first DU 702, (3) that the new cell is associated with the first DU 702, or (4) that the new cell belongs to a set of cells configured for at least one of the L1 link reestablishment procedure or the L2 link reestablishment procedure. In some aspects, the set of cells may be a configured set of cells indicated in the UE L1/L2 recovery configuration messages 710 received by the UE 704 as discussed above. The set of cells, in some aspects, may include at least one cell associated with each of the first satellite-based DU and an additional DU (e.g., a plurality of DUs associated with at least one of a same CU or one or more CUs (or network nodes) sharing a set of security parameters with the CU associated with the failed radio link) such as a set of cells associated with at least the first DU 702 and the second DU 703 that are associated with CU 701. In some aspects, the new cell may be associated with one of the first satellite-based DU and the additional DU (e.g., an additional DU configured for at least one of the L1 link reestablishment procedure or the L2 link reestablishment procedure in relation to the failed radio link). The determination that the new cell is associated with the CU 701, in some aspects, may be based on an ID of the CU associated with the first cell (e.g., a BS-CU ID 866 included in a CGI 860 associated with the first cell). In some aspects, the determination that the new cell is associated with the first satellite may be based on an ID of the first satellite associated with the first cell and associated with the new cell. The determination that the new cell is associated with the first DU 702 may be based on a DU ID included in one of a system information or a dedicated indication (e.g., included in the UE L1/L2 recovery configuration messages 710).

In some aspects, whether the L1/L2 recovery request 714A or the L1/L2 recovery request 714B includes an L1 link recovery request and/or an L2 link recovery request may be based on the new cell and whether any of the L1 or L2 parameters are able to be reused by the UE 704 for the new (e.g., reestablished) link. For example, an L2 recovery request may be able to reuse L1 (and/or some L2) parameters (if the new cell is the same cell associated with the failed radio link). The L1/L2 recovery request 714A or the L1/L2 recovery request 714B, in some aspects, may be associated with one or more of an RLC layer, a MAC layer, or a PHY layer. For example, the L1/L2 recovery request 714A or the L1/L2 recovery request 714B may be associated with one or more aspects of L1/L2 handling including a full or partial reset of MAC parameters (where a partial MAC reset may allow the UE 704 to retain an L1 configuration when reconnecting to a same cell), a suspension or resetting of timers associated with RLC, a canceling and/or suspension of a triggered behavior associated with RLC (e.g., RLC status reporting and/or RLC polling transmission), and/or a suspension of PDCP. A partial MAC reset, in some aspects, may reduce overhead associated with signaling new L1 and MAC configurations allow the UE 704 to retain (e.g., continue to use) PUCCH resources for scheduling requests and UCI. In some aspects, the L1/L2 recovery request 714A or the L1/L2 recovery request 714B may not impact one or more of the RLC or the PDCP and/or the SDAP.

Based on the L1/L2 recovery request 714A or the L1/L2 recovery request 714B, the first DU 702 or the second DU 703, respectively, may verify, at 716, that the recovery request is valid. In some aspects, the verification at 716 includes determining that the authentication value (e.g., a MAC-I) included in at least one of the L1 link recovery request or the L2 link recovery request is valid. To verify the validity of the recovery request at 716, in some aspects, one of the first DU 702 or the second DU 703 (e.g., a DU associated with the new cell identified at 712) may transmit, and the CU 701 may receive, a MAC-I request 716A including the authentication value (e.g., the MAC-I) received from the UE 704 to be verified by the CU 701. In response to the MAC-I request 716A, the CU 701 may verify, at 716B, the authentication value (e.g., the MAC-I). The verification at 716B, in some aspects, may include comparing the received authentication value to one of an authentication value stored at the CU 701 or to an authentication value calculated at CU 701 based on the MAC-I request 716A to determine if they are the same. Based on the verification at 716B, the CU 701 may transmit, and one of the first DU 702 or the second DU 703 (e.g., the DU associated with the new cell identified at 712 and/or having transmitted the MAC-I request 716A) may receive, a MAC-I result 716C indicating the results of the verification at 716B. If the authentication value is indicated to be the same in MAC-I result 716C, the first DU 702 or the second DU 703 (e.g., the DU associated with the new cell identified at 712 and/or having received the MAC-I result 716C), may verify, at 716D, the authentication value.

In some aspects, the verification at 716D may be performed by one of the first DU 702 or the second DU 703 (e.g., the DU associated with the new cell identified at 712) independently of the CU 701. The independent verification at 716D, in some aspects, may be based on the L1/L2 recovery request 714A or the L1/L2 recovery request 714B instead of the MAC-I result 716C. In some aspects for which the DU verifies the authentication value independently at 716D (e.g., without the transmission of MAC-I request 716A, the verification at 716B, or the MAC-I result 716C to the CU 701), the CU 701 may not transmit the information for the fast link recovery procedure in the DU L1/L2 recovery configuration messages 708 and the security parameters may be negotiated and/or indicated between the DU (e.g., the first DU 702 or the second DU 703) and the UE 704 within the UE L1/L2 recovery configuration messages 710. The independent verification at 716D, in some aspects, may include comparing the authentication value received in the L1/L2 recovery request 714A or the L1/L2 recovery request 714B to an authentication value stored at, or calculated by, the DU (e.g., the first DU 702 or the second DU 703 associated with the new cell identified at 712) to determine if they are the same. Based on the verification at 716D, the DU (e.g., the first DU 702 or the second DU 703 associated with verification at 716D) may transmit, and the UE 704 may receive, one of the L1/L2 recovery message 718A or the L1/L2 recovery message 718B. The L1/L2 recovery message 718A or the L1/L2 recovery message 718B, in some aspects, may include all, or part, of the contents of the L1/L2 recovery request 714A or the L1/L2 recovery request 714B (e.g., to perform content resolution). In some aspects, the L1/L2 recovery message 718A or the L1/L2 recovery message 718B may include a UE ID (e.g., UE-specific information) that identifies the L1/L2 recovery message 718A or the L1/L2 recovery message 718B as being responsive to the L1/L2 recovery request 714A or the L1/L2 recovery request 714B. the L1/L2 recovery message 718A or the L1/L2 recovery message 718B, in some aspects, may include new configuration information (L1 and/or L2 parameters and/or configurations for the reestablished link).

If the L1/L2 recovery message 718A or the L1/L2 recovery message 718B indicates that the authentication value (e.g., the MAC-I value) and the associated L1/L2 recovery request 714A or the associated L1/L2 recovery request 714B is valid, the UE 704, the DU associated with the L1/L2 recovery message 718A or the L1/L2 recovery message 718B (e.g., one of the first DU 702 or the second DU 703 associated with the new cell), and the CU 701 may resume user plane communication at 720 (e.g., may resume one or more L2 sublayers) and may exchange and/or participate in communication 722. In some aspects, resuming the user plane communication at 720 and/or exchanging, and/or participating in, communication 722 may include resuming one or more timers associated with an RLC or a PDCP. The user plane communication at 720 and/or exchanging, and/or participating in, communication 722, in some aspects, may include transmitting an indication of one or more aspects of the L1/L2 link recovery such as an RLC triggering a re-establishment, an RLC triggering a status report transmission, a related PDCP action (e.g., a PDCP data recovery and/or a PDCP status report) or an indication that an L1/L2 recovery and/or reestablishment procedure has occurred (e.g., for reporting to an operator of the network associated with the CU 701, the first DU 702, the second DU 703, and the UE 704).

However, if the L1/L2 recovery message 718A or the L1/L2 recovery message 718B indicates that the authentication value (e.g., the MAC-I value) and the associated L1/L2 recovery request 714A or the associated L1/L2 recovery request 714B are not valid, the UE 704 may initiate a reestablishment procedure associated with L3 parameters (e.g., an RRC reestablishment procedure (not shown)). Based on the reestablishment procedure associated with the L3 parameters, the UE 704, the DU associated with the L1/L2 recovery message 718A or the L1/L2 recovery message 718B (e.g., one of the first DU 702 or the second DU 703 associated with the new cell), and the CU 701 may resume user plane communication at 720 and may exchange and/or participate in communication 722.

After receiving the L1/L2 recovery message 718A or the L1/L2 recovery message 718B (or after detecting a subsequent radio link failure (not shown)), the UE 704 may update, at 724, an authentication value. The update at 724, in some aspects, may be based on the configured rule discussed above. Alternatively, or additionally, the update may be based on receiving updated security parameters (or information for the fast link recovery procedure) in association with one of resuming the user plane communication at 720 and/or exchanging, and/or participating in, communication 722.

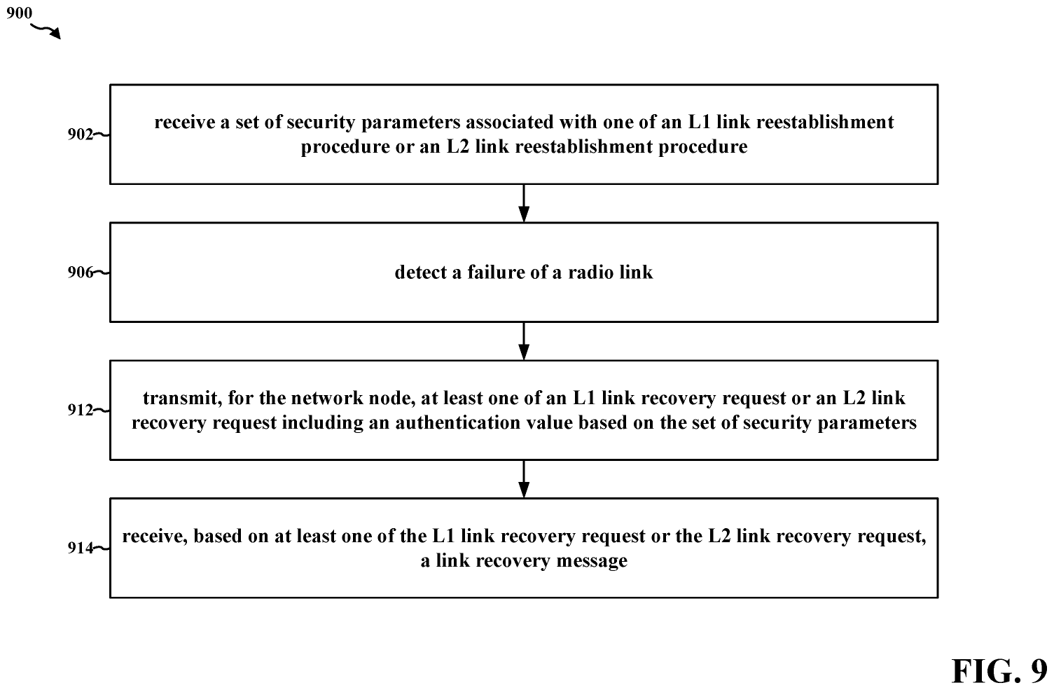

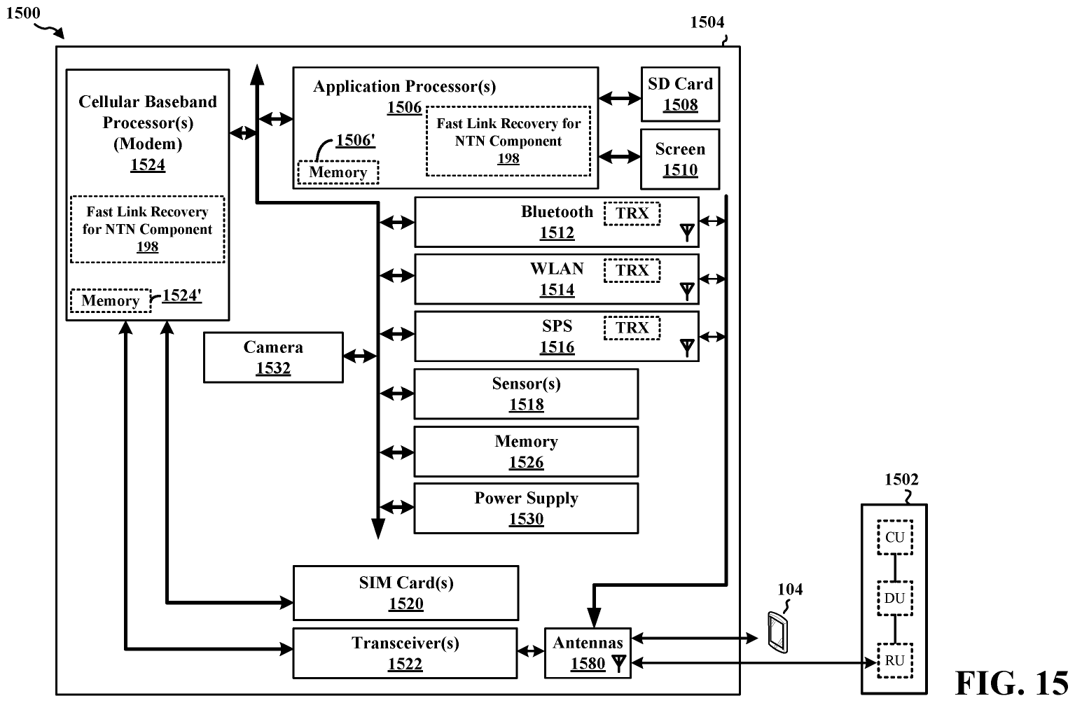

FIG. 9 is a flowchart 900 of a method of wireless communication. The method may be performed by a wireless device such as a UE (e.g., the UE 104, 404, 505, 604, 704; the apparatus 1504). At 902, the wireless device may receive a set of security parameters associated with one of an L1 link reestablishment procedure or an L2 link reestablishment procedure. For example, 902 may be performed by application processor(s) 1506, cellular baseband processor(s) 1524, transceiver(s) 1522, antenna(s) 1580, and/or fast link recovery for NTN component 198 of FIG. 15. In some aspects, the set of security parameters may include one or more of an ID of the wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, the L1 link reestablishment procedure or the L2 link reestablishment procedure reuses (is configured to reuse) L3 parameters associated with the radio link for which failure was detected. For example, referring to FIG. 7, the UE 704 may receive UE L1/L2 recovery configuration messages 710 including the information for the fast link recovery procedure from one of the first DU 702 or the CU 701 (via the first DU 702).

In some aspects, the wireless may receive an indication of a set of cells configured for at least one of the L1 link reestablishment procedure or the L2 link reestablishment procedure along with the set of security parameters. In some aspects, the set of cells may include at least one cell associated with each of a plurality of network nodes, e.g., a plurality of DUs associated with at least one of a same CU or one or more CUs (or network nodes) sharing a set of security parameters with the CU associated with the failed radio link as described above in relation to FIG. 7. For example, referring to FIG. 7, the UE 704 may receive UE L1/L2 recovery configuration messages 710 including the indication of the information set of cells configured for at least one of the L1 link reestablishment procedure or the L2 link reestablishment procedure (e.g., the set of cells associated with at least the first DU 702 (and, in some aspects, the second DU 703) that are associated with CU 701 or with a core network (not shown)).

At 906, the wireless device may detect a failure of a first radio link. For example, 906 may be performed by application processor(s) 1506, cellular baseband processor(s) 1524, transceiver(s) 1522, antenna(s) 1580, and/or fast link recovery for NTN component 198 of FIG. 15. In some aspects, the radio link may be a first radio link with a first cell (e.g., associated with a first network node). For example, referring to FIG. 7, the UE 704 may, at 712, detect a radio link failure (and identify a cause for the failure) for a radio link with a first cell of the first DU 702.

Based on detecting the failure at 906, the wireless device may identify a new cell to which to connect. In some aspects, the new cell may be one of the first cell or a second cell associated with a network node (e.g., the first network node or a second network node) for which the L1 link reestablishment procedure or the L2 link reestablishment procedure may be performed. For example, referring to FIG. 7, the UE 704 may, at 712, identify a (new) cell for a link reestablishment, where the new cell may be the same (first) cell, a different cell associated with the first DU 702, or a cell associated with the second DU 703.

As part of identifying the new cell to which to connect, the wireless device may determine that the new cell is configured for one of the L1 link reestablishment procedure or the L2 link reestablishment procedure. In some aspects, the first cell may be associated with a first network node that may be a first satellite-based DU associated with a first satellite in an NTN. Determining that the new cell is configured for one of the L1 link reestablishment procedure or the L2 link reestablishment procedure, in some aspects, may include determining one of (1) that the new cell is associated with the first satellite, (2) that the new cell is associated with the first satellite-based DU, or (3) that the new cell belongs to the set of cells configured for at least one of the L1 link reestablishment procedure or the L2 link reestablishment procedure (e.g., based on the indication of the set of cells received at 902). The set of cells, in some aspects, may include at least one cell associated with each of the first satellite-based DU and an additional DU (e.g., a plurality of DUs associated with at least one of a same CU or one or more CUs (or network nodes) sharing a set of security parameters with the CU associated with the failed radio link) such as a set of cells associated with at least the first DU 702 (or first satellite-based DU 622) and the second DU 703 (or second satellite-based DU 642) that are associated with CU 701 (or network entity 606)). In some aspects, the new cell may be associated with one of the first satellite-based DU and the additional DU (e.g., an additional DU configured for at least one of the L1 link reestablishment procedure or the L2 link reestablishment procedure in relation to the failed radio link). For example, referring to FIG. 7, the UE 704 may, as part of identifying the (new) cell for the link reestablishment at 712, determine that the new cell is configured to use the fast link recovery procedure.

At 912, the wireless device may transmit, for a network node configured for at least one of the L1 link reestablishment procedure or the L2 link reestablishment procedure, an authentication value based on the set of security parameters included in at least one of an L1 link recovery request or an L2 link recovery request. For example, 912 may be performed by application processor(s) 1506, cellular baseband processor(s) 1524, transceiver(s) 1522, antenna(s) 1580, and/or fast link recovery for NTN component 198 of FIG. 15. In some aspects, the authentication value may be a MAC-I value. The L1 link recovery request or the L2 link recovery request, in some aspects, may include one or more of the ID of the wireless device, the C-RNTI, the TEID, the MAC-I value, a cause value indicating a type of failure associated with the failure of the radio link, an ID of the first network node, or an ID of a network entity associated with the first network node. In some aspects, the network entity associated with the first network node may include a CU. The L1 link recovery request or the L2 link recovery request, in some aspects, may be associated with one or more of resetting and/or reestablishing one or more of an RLC layer, a MAC layer, a PHY layer, or another layer (e.g., a newly-defined layer associated with L1 and/or L2 functions). For example, referring to FIG. 7, the UE 704 may transmit the L1/L2 recovery request 714A or the L1/L2 recovery request 714B that may include one or more of the ID of the UE 704, the C-RNTI, the TEID, the MAC-I value, a cause value indicating a type of failure associated with the failure of the radio link (e.g., T310 expiry, RACH failure, RLC failure, handover (HO) failure, etc.), an ID of a network node (e.g., the first DU 702 or the second DU 703 associated with at least one of the first radio link or the new cell), an ID of a network entity (e.g., the CU 701) associated with the network node, or an LCID that may be associated with (or identify the L1/L2 recovery request 714A or the L1/L2 recovery request 714B as being associated with) the L1 link reestablishment procedure or the L2 link reestablishment procedure.

At 914, the wireless device may receive, based on at least one of the L1 link recovery request or the L2 link recovery request transmitted at 912, a link recovery message. For example, 914 may be performed by application processor(s) 1506, cellular baseband processor(s) 1524, transceiver(s) 1522, antenna(s) 1580, and/or fast link recovery for NTN component 198 of FIG. 15. In some aspects, the link recovery message may be at least one of an L1 recovery message or an L2 recovery message that addresses the parts of at least one of the L1 recovery request or the L2 recovery request. In some aspects, the L1 link reestablishment procedure or the L2 link reestablishment procedure reuses (is configured to reuse) L3 parameters associated with the radio link for which failure was detected. For example, referring to FIG. 7, the UE 704 may receive the L1/L2 recovery message 718A or the L1/L2 recovery message 718B and, if the L1/L2 recovery message 718A or the L1/L2 recovery message 718B indicates that the associated L1/L2 recovery request 714A or the associated L1/L2 recovery request 714B is valid, the UE 704, the DU associated with the L1/L2 recovery message 718A or the L1/L2 recovery message 718B (e.g., one of the first DU 702 or the second DU 703 associated with the new cell), and the CU 701 may resume user plane communication at 720 (e.g., may resume one or more L2 sublayers) and may exchange and/or participate in communication 722.

After transmitting the authentication value based on the set of security parameters included in at least one of an L1 link recovery request or an L2 link recovery request at 912 or after receiving the link recovery message, the wireless device may update the at least one parameter in the set of security parameters. In some aspects, the at least one parameter in the set of security parameters is updated for a calculation of a different authentication value to be used for a subsequent L1 link recovery request or a subsequent L2 link recovery request. The update at 916, in some aspects, may be based on a configured rule at the wireless device. Accordingly, in some aspects, a first authentication value for a first L1/L2 recovery request (e.g., the L1/L2 recovery request transmitted at 912) may be based on the set of values (or security parameters) received at 902 with subsequent authentication values for subsequent L1/L2 recovery requests based on the configured rules. In some aspects, updating the at least one parameter in the set of security parameters, may further include receiving an update to at least one parameter in the set of security parameters. The update, in some aspects, may be received from one of a network node (e.g., a DU) or from a network entity (e.g., a CU) based on the implementation of the verification procedure as described in relation to FIG. 7. For example, referring to FIG. 7, the UE 704 may update the authentication value at 724 based on a configured rule or one or more updated security parameters (or information for the fast link recovery procedure) in association with one of resuming the user plane communication at 720 and/or exchanging, and/or participating in, communication 722.

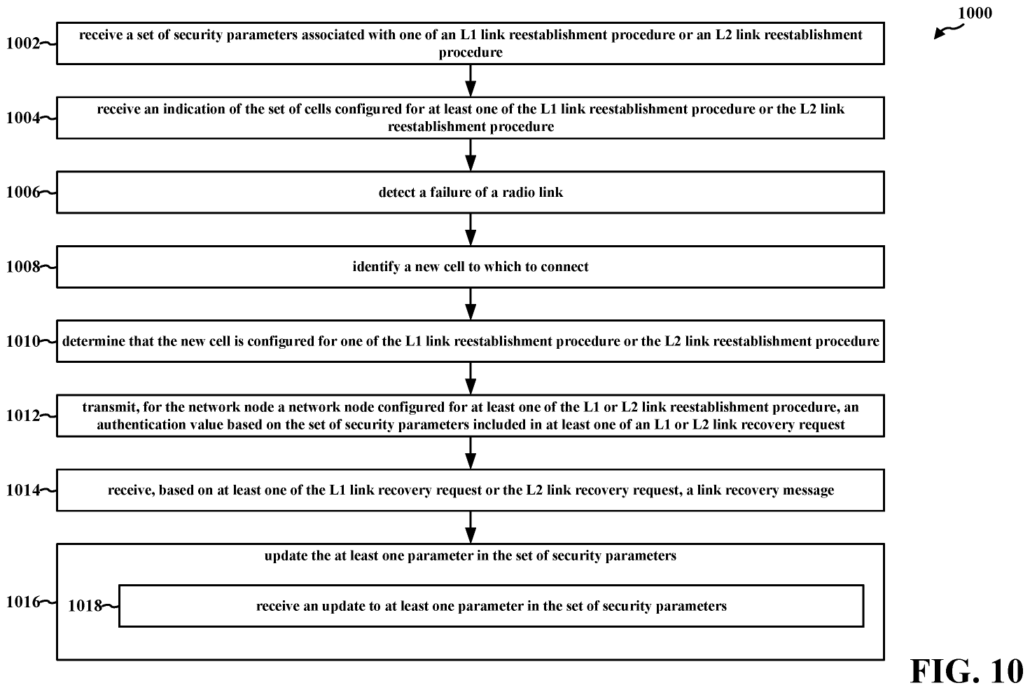

FIG. 10 is a flowchart 1000 of a method of wireless communication. The method may be performed by a wireless device such as a UE (e.g., the UE 104, 404, 505, 604, 704; the apparatus 1504). At 1002, the wireless device may receive a set of security parameters associated with one of an L1 link reestablishment procedure or an L2 link reestablishment procedure. For example, 1002 may be performed by application processor(s) 1506, cellular baseband processor(s) 1524, transceiver(s) 1522, antenna(s) 1580, and/or fast link recovery for NTN component 198 of FIG. 15. In some aspects, the set of security parameters may include one or more of an ID of the wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, the L1 link reestablishment procedure or the L2 link reestablishment procedure reuses (is configured to reuse) L3 parameters associated with the radio link for which failure was detected. For example, referring to FIG. 7, the UE 704 may receive UE L1/L2 recovery configuration messages 710 including the information for the fast link recovery procedure from one of the first DU 702 or the CU 701 (via the first DU 702).

At 1004, the wireless may receive an indication of a set of cells configured for at least one of the L1 link reestablishment procedure or the L2 link reestablishment procedure. For example, 1004 may be performed by application processor(s) 1506, cellular baseband processor(s) 1524, transceiver(s) 1522, antenna(s) 1580, and/or fast link recovery for NTN component 198 of FIG. 15. In some aspects, the set of cells may include at least one cell associated with each of a plurality of network nodes, e.g., a plurality of DUs associated with at least one of a same CU or one or more CUs (or network nodes) sharing a set of security parameters with the CU associated with the failed radio link as described above in relation to FIG. 7. For example, referring to FIG. 7, the UE 704 may receive UE L1/L2 recovery configuration messages 710 including the indication of the information set of cells configured for at least one of the L1 link reestablishment procedure or the L2 link reestablishment procedure (e.g., the set of cells associated with at least the first DU 702 (and, in some aspects, the second DU 703) that are associated with CU 701 or with a core network (not shown)).

At 1006, the wireless device may detect a failure of a first radio link. For example, 1006 may be performed by application processor(s) 1506, cellular baseband processor(s) 1524, transceiver(s) 1522, antenna(s) 1580, and/or fast link recovery for NTN component 198 of FIG. 15. In some aspects, the radio link may be a first radio link with a first cell (e.g., associated with a first network node). For example, referring to FIG. 7, the UE 704 may, at 712, detect a radio link failure (and identify a cause for the failure) for a radio link with a first cell of the first DU 702.

At 1008, the wireless device may identify a new cell to which to connect. For example, 1008 may be performed by application processor(s) 1506, cellular baseband processor(s) 1524, transceiver(s) 1522, antenna(s) 1580, and/or fast link recovery for NTN component 198 of FIG. 15. In some aspects, the new cell may be one of the first cell or a second cell associated with a network node (e.g., the first network node or a second network node) for which the L1 link reestablishment procedure or the L2 link reestablishment procedure may be performed. For example, referring to FIG. 7, the UE 704 may, at 712, identify a (new) cell for a link reestablishment, where the new cell may be the same (first) cell, a different cell associated with the first DU 702, or a cell associated with the second DU 703.

At 1010, the wireless device may determine that the new cell is configured for one of the L1 link reestablishment procedure or the L2 link reestablishment procedure. For example, 1010 may be performed by application processor(s) 1506, cellular baseband processor(s) 1524, and/or fast link recovery for NTN component 198 of FIG. 15. In some aspects, the first cell may be associated with a first network node that may be a first satellite-based DU associated with a first satellite in an NTN. Determining that the new cell is configured for one of the L1 link reestablishment procedure or the L2 link reestablishment procedure, in some aspects, may include determining one of (1) that the new cell is associated with the first satellite, (2) that the new cell is associated with the first satellite-based DU, or (3) that the new cell belongs to the set of cells configured for at least one of the L1 link reestablishment procedure or the L2 link reestablishment procedure (e.g., based on the indication of the set of cells received at 1004). The set of cells, in some aspects, may include at least one cell associated with each of the first satellite-based DU and an additional DU (e.g., a plurality of DUs associated with at least one of a same CU or one or more CUs (or network nodes) sharing a set of security parameters with the CU associated with the failed radio link) such as a set of cells associated with at least the first DU 702 (or first satellite-based DU 622) and the second DU 703 (or second satellite-based DU 642) that are associated with CU 701 (or network entity 606)). In some aspects, the new cell may be associated with one of the first satellite-based DU and the additional DU (e.g., an additional DU configured for at least one of the L1 link reestablishment procedure or the L2 link reestablishment procedure in relation to the failed radio link). For example, referring to FIG. 7, the UE 704 may, as part of identifying the (new) cell for the link reestablishment at 712, determine that the new cell is configured to use the fast link recovery procedure.

At 1012, the wireless device may transmit, for a network node configured for at least one of the L1 link reestablishment procedure or the L2 link reestablishment procedure, an authentication value based on the set of security parameters included in at least one of an L1 link recovery request or an L2 link recovery request. For example, 1012 may be performed by application processor(s) 1506, cellular baseband processor(s) 1524, transceiver(s) 1522, antenna(s) 1580, and/or fast link recovery for NTN component 198 of FIG. 15. In some aspects, the authentication value may be a MAC-I value. The L1 link recovery request or the L2 link recovery request, in some aspects, may include one or more of the ID of the wireless device, the C-RNTI, the TEID, the MAC-I value, a cause value indicating a type of failure associated with the failure of the radio link, an ID of the first network node, or an ID of a network entity associated with the first network node. In some aspects, the network entity associated with the first network node may include a CU. The L1 link recovery request or the L2 link recovery request, in some aspects, may be associated with, e.g., transmitted via, or in association with, one or more of an RLC layer, a MAC layer, a PHY layer, or another layer (e.g., a newly-defined layer associated with L1 and/or L2 functions). For example, referring to FIG. 7, the UE 704 may transmit the L1/L2 recovery request 714A or the L1/L2 recovery request 714B that may include one or more of the ID of the UE 704, the C-RNTI, the TEID, the MAC-I value, a cause value indicating a type of failure associated with the failure of the radio link (e.g., T310 expiry, RACH failure, RLC failure, handover (HO) failure, etc.), an ID of a network node (e.g., the first DU 702 or the second DU 703 associated with at least one of the first radio link or the new cell), an ID of a network entity (e.g., the CU 701) associated with the network node, or LCID that may be associated with (or identify the L1/L2 recovery request 714A or the L1/L2 recovery request 714B as being associated with) the L1 link reestablishment procedure or the L2 link reestablishment procedure.

At 1014, the wireless device may receive, based on at least one of the L1 link recovery request or the L2 link recovery request transmitted at 1012, a link recovery message. For example, 1014 may be performed by application processor(s) 1506, cellular baseband processor(s) 1524, transceiver(s) 1522, antenna(s) 1580, and/or fast link recovery for NTN component 198 of FIG. 15. In some aspects, the link recovery message may be at least one of an L1 recovery message or an L2 recovery message that addresses the parts of at least one of the L1 recovery request or the L2 recovery request. In some aspects, the L1 link reestablishment procedure or the L2 link reestablishment procedure reuses (is configured to reuse) L3 parameters associated with the radio link for which failure was detected. For example, referring to FIG. 7, the UE 704 may receive the L1/L2 recovery message 718A or the L1/L2 recovery message 718B and, if the L1/L2 recovery message 718A or the L1/L2 recovery message 718B indicates that the associated L1/L2 recovery request 714A or the associated L1/L2 recovery request 714B is valid, the UE 704, the DU associated with the L1/L2 recovery message 718A or the L1/L2 recovery message 718B (e.g., one of the first DU 702 or the second DU 703 associated with the new cell), and the CU 701 may resume user plane communication at 720 (e.g., may resume one or more L2 sublayers) and may exchange and/or participate in communication 722.

At 1016, the wireless device may update the at least one parameter in the set of security parameters. For example, 1016 may be performed by application processor(s) 1506, cellular baseband processor(s) 1524, transceiver(s) 1522, antenna(s) 1580, and/or fast link recovery for NTN component 198 of FIG. 15. In some aspects, the at least one parameter in the set of security parameters is updated for a calculation of a different authentication value to be used for a subsequent L1 link recovery request or a subsequent L2 link recovery request. The update at 1016, in some aspects, may be based on a configured rule at the wireless device. Accordingly, in some aspects, a first authentication value for a first L1/L2 recovery request (e.g., the L1/L2 recovery request transmitted at 1012) may be based on the set of values (or security parameters) received at 1002 with subsequent authentication values for subsequent L1/L2 recovery requests based on the configured rules. In some aspects, updating the at least one parameter in the set of security parameters at 1016, may further include receiving, at 1018, an update to at least one parameter in the set of security parameters. The update received at 1018, in some aspects, may be received from one of a network node (e.g., a DU) or from a network entity (e.g., a CU) based on the implementation of the verification procedure as described in relation to FIG. 7. For example, referring to FIG. 7, the UE 704 may update the authentication value at 724 based on a configured rule or one or more updated security parameters (or information for the fast link recovery procedure) in association with one of resuming the user plane communication at 720 and/or exchanging, and/or participating in, communication 722.

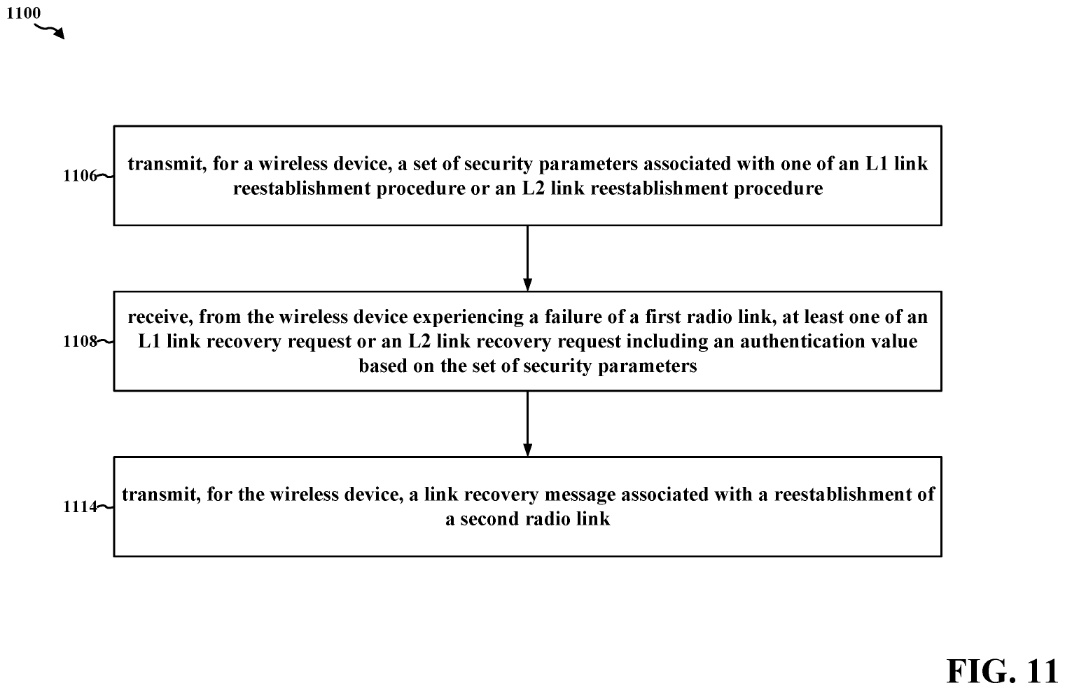

FIG. 11 is a flowchart 1100 of a method of wireless communication. The method may be performed by a network node that may be a DU of a base station (e.g., the base station 102; the DU 130, 1630; the first satellite-based DU 622; the second satellite-based DU 642; the first DU 702; the second DU 703; the network entity 1502, 1602, 1760). In some aspects, the network node may be a satellite-based DU associated with a first satellite in an NTN that may be in communication with a wireless device (e.g., a UE) over a first radio link. In some aspects, the network node (e.g., the DU) or the associated satellite may be associated with a plurality of cells associated with the L1 link reestablishment procedure or the L2 link reestablishment procedure.

In some aspects, the network node may receive, from a network entity, one or more indications of values associated with a set of security parameters associated with one of an L1 link reestablishment procedure or an L2 link reestablishment procedure. The received one or more indications, in some aspects may relate to one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, one or more of the above values may be omitted if the network node can independently verify requests associated with one of the L1 link reestablishment procedure or the L2 link reestablishment procedure. In some aspects, the L1 link reestablishment procedure or the L2 link reestablishment procedure reuses (is configured to reuse) L3 parameters associated with the first radio link. For example, referring to FIG. 7, the first DU 702 may receive DU L1/L2 recovery configuration messages 708 including the information for the fast link recovery procedure from the CU 701.

The network node, in some aspects may generate, based on the one or more indications, the set of security parameters. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. For example, referring to FIG. 7, the first DU 702 may transmit, and the UE 704 may receive, the UE L1/L2 recovery configuration messages 710 including the information for the fast link recovery procedure.

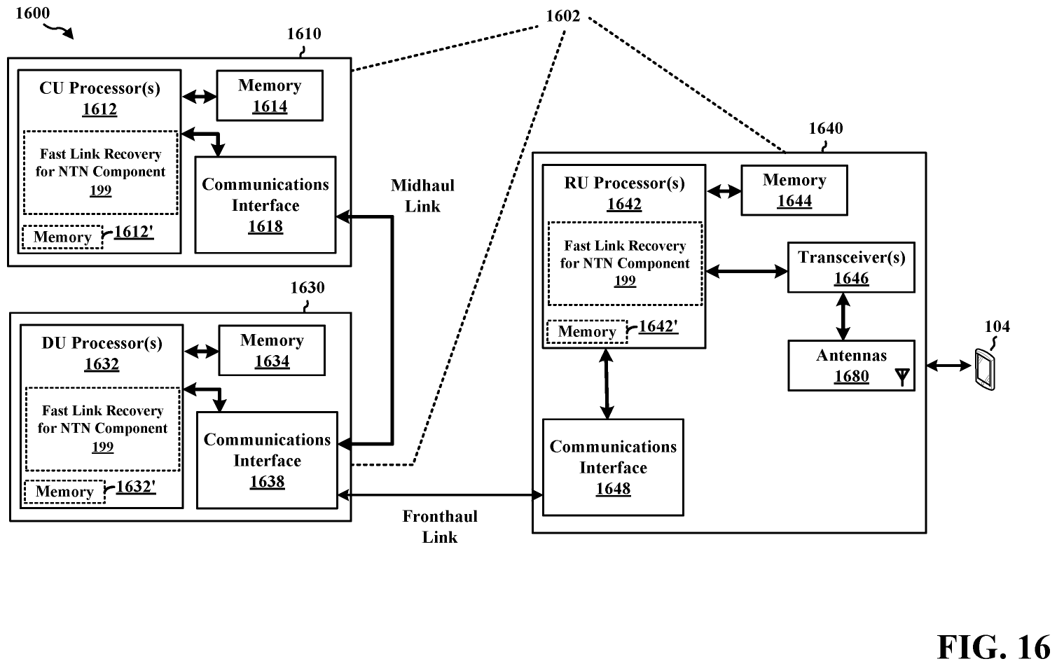

At 1106, the network node may transmit, for a wireless device, the set of security parameters associated with one of the L1 link reestablishment procedure or the L2 link reestablishment procedure. For example, 1106 may be performed by DU processor(s) 1632, RU processor(s) 1642, transceiver(s) 1646, antenna(s) 1680, and/or fast link recovery for NTN component 199 of FIG. 16. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. For example, referring to FIG. 7, the first DU 702 may transmit, and the UE 704 may receive, the UE L1/L2 recovery configuration messages 710 including the information for the fast link recovery procedure.

At 1108, the network node may receive, from the wireless device experiencing a failure of a first radio link, at least one of an L1 link recovery request or an L2 link recovery request. For example, 1108 may be performed by DU processor(s) 1632, RU processor(s) 1642, transceiver(s) 1646, antenna(s) 1680, and/or fast link recovery for NTN component 199 of FIG. 16. In some aspects, at least one the L1 link recovery request or the L2 link recovery request may include an authentication value based on the set of security parameters. The first radio link, in some aspects, may be associated with a first cell of a plurality of cells associated with the network node and at least one of the L1 link recovery request or the L2 link recovery request may be associated with a second cell of the plurality of cells associated with the network node. In some aspects, the authentication value may be, or include, a MAC-I value, and the L1 link recovery request or the L2 link recovery request may include one or more of the ID of the wireless device, the C-RNTI, the TEID, the MAC-I value, a cause value indicating a type of failure associated with the failure of the first radio link, an ID of the network node, or an identify of a network entity associated with the network node. The L1 link recovery request or the L2 link recovery request, in some aspects, may be associated with one or more of an RLC layer, a MAC layer, or a PHY layer. For example, referring to FIG. 7, the first DU 702 may receive from the UE 704 the L1/L2 recovery request 714A that may include one or more of the ID of the UE 704, the C-RNTI, the TEID, the MAC-I value, a cause value indicating a type of failure associated with the failure of the radio link (e.g., T310 expiry, RACH failure, RLC failure, HO failure, etc.), an ID of a network node (e.g., the first DU 702 or the second DU 703 associated with at least one of the first radio link or the new cell), an ID of a network entity (e.g., the CU 701) associated with the network node, or an LCID that may be associated with (or identify the L1/L2 recovery request 714A or the L1/L2 recovery request 714B as being associated with) the L1 link reestablishment procedure or the L2 link reestablishment procedure.

The network node, in some aspects, may verify, based on the authentication value, that at least one of the L1 link recovery request or the L2 link recovery request is valid. In some aspects, in order to perform the verification at 1110, the network node may determine that the authentication value included in at least one of the L1 link recovery request or the L2 link recovery request matches a locally-stored authentication value. The locally stored value, in some aspects, may be received from the network entity or may be calculated based on values received from the network entity and/or based on an algorithm indicated by the network entity. For example, referring to FIG. 7, the first DU 702 may, at 716D, verify the L1/L2 recovery request 714A by comparing the authentication value received in the L1/L2 recovery request 714A to an authentication value stored at, or calculated by, the first DU 702 to determine if they are the same.

In some aspects, in order to perform the verification, the network node may transmit, for a network entity associated with the first radio link, a verification request including the authentication value and receive, from the network entity, a verification response verifying that the authentication value is valid. In some aspects, the authentication value may be the MAC-I value received from the wireless device at 1108. Referring to FIG. 7, for example, the first DU 702 may transmit the MAC-I request 716A including the authentication value (e.g., the MAC-I) received from the UE 704 to be verified by the CU 701 and may receive the MAC-I result 716C indicating the results of a verification performed by the CU 701 at 716B and verify, at 716AD, the L1/L2 recovery request 714A based on the MAC-I result 716C.

At 1114, the network node may transmit, for the wireless device, a link recovery message associated with a reestablishment of a second radio link. For example, 1114 may be performed by DU processor(s) 1632, RU processor(s) 1642, transceiver(s) 1646, antenna(s) 1680, and/or fast link recovery for NTN component 199 of FIG. 16. In some aspects, the link recovery message associated with the reestablishment of the second radio link may include all, or a part, of at least one of the L1 link recovery request or the L2 link recovery request to perform a contention resolution. For example, referring to FIG. 7, the first DU 702 may transmit the L1/L2 recovery message 718A for the UE 704 to allow a resumption user plane communication at 720 (e.g., the UE 704, the first DU 702, and/or the CU 701 may resume one or more L2 sublayers) and the exchange and/or participation in communication 722.

In some aspects, the network node may receive, from a network entity, an update to the at least one parameter in the set of security parameters. In some aspects, the updated at least one parameter may be for use for verifying a subsequent L1 link recovery request or a subsequent L2 link recovery request. For example, referring to FIG. 7, the first DU 702 may receive at least one updated parameter in association with one of resuming the user plane communication at 720 and/or exchanging, and/or participating in, communication 722. In some aspects, the network node may transmit, for the wireless device, an update to at least one parameter in the set of security parameters. In some aspects, the update to the at least one parameter may be based on the at least one updated parameter received from the network entity. The update to the at least one parameter, in some aspects (e.g., when the network node performs an independent verification of an authentication value), may be based on a determination made, and/or an update, at the network node and may be for the wireless device to use to determine an authentication value for a subsequent L1 link recovery request or a subsequent L2 link recovery request. For example, referring to FIG. 7, the first DU 702 may provide at least one updated parameter to the UE 704 in association with one of resuming the user plane communication at 720 and/or exchanging, and/or participating in, communication 722.

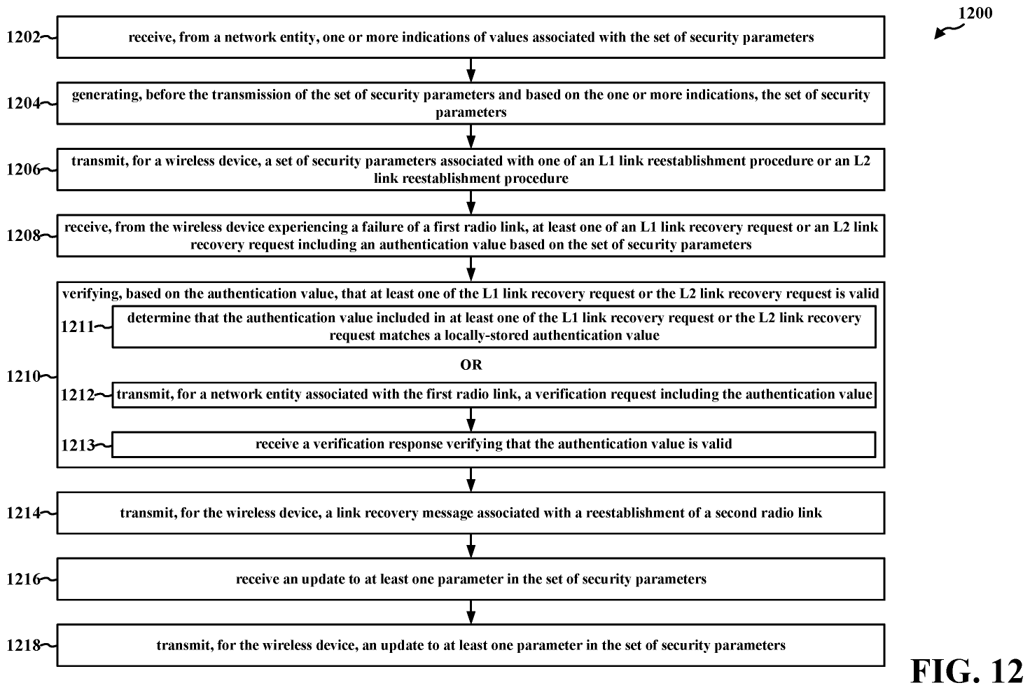

FIG. 12 is a flowchart 1200 of a method of wireless communication. The method may be performed by a network node that may be a DU of a base station (e.g., the base station 102; the DU 130, 1630; the first satellite-based DU 622; the second satellite-based DU 642; the first DU 702; the second DU 703; the network entity 1502, 1602, 1760). In some aspects, the network node may be a satellite-based DU associated with a first satellite in an NTN that may be in communication with a wireless device (e.g., a UE) over a first radio link. In some aspects, the network node (e.g., the DU) or the associated satellite may be associated with a plurality of cells associated with the L1 link reestablishment procedure or the L2 link reestablishment procedure.

At 1202, the network node may receive, from a network entity, one or more indications of values associated with a set of security parameters associated with one of an L1 link reestablishment procedure or an L2 link reestablishment procedure. For example, 1202 may be performed by DU processor(s) 1632, RU processor(s) 1642, transceiver(s) 1646, antenna(s) 1680, and/or fast link recovery for NTN component 199 of FIG. 16. The received one or more indications, in some aspects may relate to one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, one or more of the above values may be omitted if the network node can independently verify requests associated with one of the L1 link reestablishment procedure or the L2 link reestablishment procedure. In some aspects, the L1 link reestablishment procedure or the L2 link reestablishment procedure reuses (is configured to reuse) L3 parameters associated with the first radio link. For example, referring to FIG. 7, the first DU 702 may receive DU L1/L2 recovery configuration messages 708 including the information for the fast link recovery procedure from the CU 701.

At 1204, the network node may generate, based on the one or more indications, the set of security parameters. For example, 1204 may be performed by DU processor(s) 1632, RU processor(s) 1642, transceiver(s) 1646, antenna(s) 1680, and/or fast link recovery for NTN component 199 of FIG. 16. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. For example, referring to FIG. 7, the first DU 702 may transmit, and the UE 704 may receive, the UE L1/L2 recovery configuration messages 710 including the information for the fast link recovery procedure.

At 1206, the network node may transmit, for a wireless device, the set of security parameters associated with one of the L1 link reestablishment procedure or the L2 link reestablishment procedure. For example, 1206 may be performed by DU processor(s) 1632, RU processor(s) 1642, transceiver(s) 1646, antenna(s) 1680, and/or fast link recovery for NTN component 199 of FIG. 16. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. For example, referring to FIG. 7, the first DU 702 may transmit, and the UE 704 may receive, the UE L1/L2 recovery configuration messages 710 including the information for the fast link recovery procedure.

At 1208, the network node may receive, from the wireless device experiencing a failure of a first radio link, at least one of an L1 link recovery request or an L2 link recovery request. For example, 1208 may be performed by DU processor(s) 1632, RU processor(s) 1642, transceiver(s) 1646, antenna(s) 1680, and/or fast link recovery for NTN component 199 of FIG. 16. In some aspects, at least one the L1 link recovery request or the L2 link recovery request may include an authentication value based on the set of security parameters. The first radio link, in some aspects, may be associated with a first cell of a plurality of cells associated with the network node and at least one of the L1 link recovery request or the L2 link recovery request may be associated with a second cell of the plurality of cells associated with the network node. In some aspects, the authentication value may be, or include, a MAC-I value, and the L1 link recovery request or the L2 link recovery request may include one or more of the ID of the wireless device, the C-RNTI, the TEID, the MAC-I value, a cause value indicating a type of failure associated with the failure of the first radio link, an ID of the network node, or an identify of a network entity associated with the network node. The L1 link recovery request or the L2 link recovery request, in some aspects, may be associated with one or more of an RLC layer, a MAC layer, or a PHY layer. For example, referring to FIG. 7, the first DU 702 may receive from the UE 704 the L1/L2 recovery request 714A that may include one or more of the ID of the UE 704, the C-RNTI, the TEID, the MAC-I value, a cause value indicating a type of failure associated with the failure of the radio link (e.g., T310 expiry. RACH failure, RLC failure, HO failure, etc.), an ID of a network node (e.g., the first DU 702 or the second DU 703 associated with at least one of the first radio link or the new cell), an ID of a network entity (e.g., the CU 701) associated with the network node, or an LCID that may be associated with (or identify the L1/L2 recovery request 714A or the L1/L2 recovery request 714B as being associated with) the L1 link reestablishment procedure or the L2 link reestablishment procedure.

At 1210 the network node may verify, based on the authentication value, that at least one of the L1 link recovery request or the L2 link recovery request is valid. In some aspects, in order to perform the verification at 1210, the network node may determine, at 1211, that the authentication value included in at least one of the L1 link recovery request or the L2 link recovery request matches a locally-stored authentication value. The locally stored value, in some aspects, may be received from the network entity or may be calculated based on values received from the network entity and/or based on an algorithm indicated by the network entity. For example, referring to FIG. 7, the first DU 702 may, at 716D, verify the L1/L2 recovery request 714A by comparing the authentication value received in the L1/L2 recovery request 714A to an authentication value stored at, or calculated by, the first DU 702 to determine if they are the same.

In some aspects, in order to perform the verification at 1210, the network node may, at 1212, transmit, for a network entity associated with the first radio link, a verification request including the authentication value and, at 1213, may receive a verification response verifying that the authentication value is valid. In some aspects, the authentication value may be the MAC-I value received from the wireless device at 1208. Referring to FIG. 7, for example, the first DU 702 may transmit the MAC-I request 716A including the authentication value (e.g., the MAC-I) received from the UE 704 to be verified by the CU 701 and may receive the MAC-I result 716C indicating the results of a verification performed by the CU 701 at 716B and verify, at 716AD, the L1/L2 recovery request 714A based on the MAC-I result 716C. For example, 1210 (and 1211, 1212, and 1213) may be performed by DU processor(s) 1632, RU processor(s) 1642, transceiver(s) 1646, antenna(s) 1680, and/or fast link recovery for NTN component 199 of FIG. 16.

At 1214, the network node may transmit, for the wireless device, a link recovery message associated with a reestablishment of a second radio link. For example, 1214 may be performed by DU processor(s) 1632, RU processor(s) 1642, transceiver(s) 1646, antenna(s) 1680, and/or fast link recovery for NTN component 199 of FIG. 16. In some aspects, the link recovery message associated with the reestablishment of the second radio link may include all, or a part, of at least one of the L1 link recovery request or the L2 link recovery request to perform a contention resolution. For example, referring to FIG. 7, the first DU 702 may transmit the L1/L2 recovery message 718A for the UE 704 to allow a resumption user plane communication at 720 (e.g., the UE 704, the first DU 702, and/or the CU 701 may resume one or more L2 sublayers) and the exchange and/or participation in communication 722.

At 1216, the network node may receive, from a network entity, an update to the at least one parameter in the set of security parameters. For example, 1216 may be performed by DU processor(s) 1632, RU processor(s) 1642, transceiver(s) 1646, antenna(s) 1680, and/or fast link recovery for NTN component 199 of FIG. 16. In some aspects, the updated at least one parameter may be for use for verifying a subsequent L1 link recovery request or a subsequent L2 link recovery request. For example, referring to FIG. 7, the first DU 702 may receive at least one updated parameter in association with one of resuming the user plane communication at 720 and/or exchanging, and/or participating in, communication 722.

At 1218, the network node may transmit, for the wireless device, an update to at least one parameter in the set of security parameters. For example, 1218 may be performed by DU processor(s) 1632, RU processor(s) 1642, transceiver(s) 1646, antenna(s) 1680, and/or fast link recovery for NTN component 199 of FIG. 16. In some aspects, the update to the at least one parameter may be based on the at least one updated parameter received from the network entity. The update to the at least one parameter, in some aspects (e.g., when the network node performs an independent verification of an authentication value), may be based on a determination made, and/or an update, at the network node and may be for the wireless device to use to determine an authentication value for a subsequent L1 link recovery request or a subsequent L2 link recovery request. For example, referring to FIG. 7, the first DU 702 may provide at least one updated parameter to the UE 704 in association with one of resuming the user plane communication at 720 and/or exchanging, and/or participating in, communication 722.

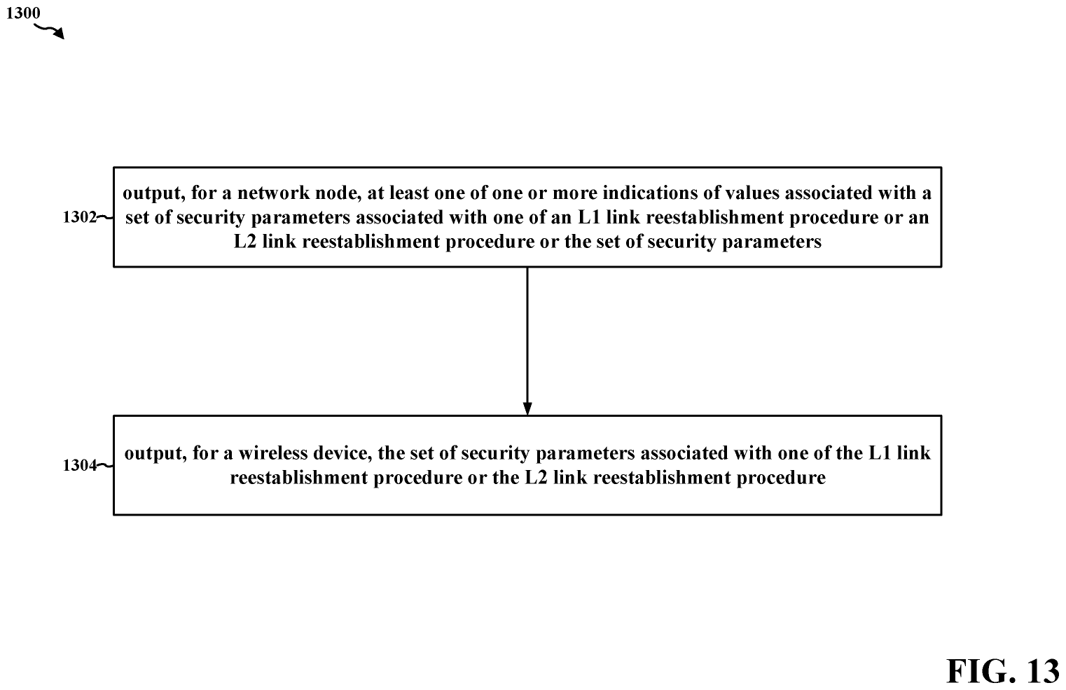

FIG. 13 is a flowchart 1300 of a method of wireless communication. The method may be performed by a network node that may be a CU of a base station or an element of a network entity (e.g., the base station 102; the CU 110, 701, 1610; the network entity 606; the network entity 1502, 1602, 1760). In some aspects, the network entity may be a CU associated with a plurality of DUs including at least one DU (e.g., a satellite-based DU in an NTN) that may be in communication with a wireless device (e.g., a UE) over a first radio link. In some aspects, the CU and one or more of the DUs (or a satellite associated with one or more of the DUs) in the plurality of DUs may be associated with a plurality of cells associated with the L1 link reestablishment procedure or the L2 link reestablishment procedure.

At 1302, the network node may output, for a network node, at least one of one or more indications of values associated with a set of security parameters associated with one of an L1 link reestablishment procedure or an L2 link reestablishment procedure or the set of security parameters. For example, 1302 may be performed by CU processor(s) 1612, transceiver(s) 1646, antenna(s) 1680, network processor 1712, network interface 1780, and/or fast link recovery for NTN component 199 of FIG. 16. The one or more indications output by the network entity, in some aspects may relate to one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, one or more of the above values may be omitted if the network node can independently verify requests associated with one of the L1 link reestablishment procedure or the L2 link reestablishment procedure. In some aspects, the L1 link reestablishment procedure or the L2 link reestablishment procedure reuses (is configured to reuse) L3 parameters associated with the first radio link. For example, referring to FIG. 7, the CU 701 may transmit, for the first DU 702 and or the second DU 703, DU L1/L2 recovery configuration messages 708 including the information for the fast link recovery procedure.

At 1304, the network entity may output, for a wireless device, the set of security parameters associated with one of the L1 link reestablishment procedure or the L2 link reestablishment procedure. For example, 1304 may be performed by CU processor(s) 1612, transceiver(s) 1646, antenna(s) 1680, network processor 1712, network interface 1780, and/or fast link recovery for NTN component 199 of FIG. 16. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. As described for the one of one or more indications of values associated with the set of security parameters, in some aspects, one or more of the possible security parameters described above may be omitted if the network node can independently verify requests associated with one of the L1 link reestablishment procedure or the L2 link reestablishment procedure. For example, referring to FIG. 7, the CU 701 may transmit, and the UE 704 may receive, the UE L1/L2 recovery configuration messages 710 including the information for the fast link recovery procedure.

Based on the at least one of one or more indications of values associated with a set of security parameters or the set of security parameters, in some aspects, the network entity may obtain, from a network node associated with a first radio link that has experienced a failure, a verification request including an authentication value based on the set of security parameters. The authentication value, in some aspects, may be a MAC-I value to be compared to a MAC-I value calculated, and/or stored at, the network entity and the network entity may verify the authentication value by performing the comparison. For example, referring to FIG. 7, the CU 701 may receive, a MAC-I request 716A transmitted by one of the first DU 702 or the second DU 703, including the MAC-I value.

The network entity, in some aspects, may output, for the network node, a verification response verifying that the authentication value is valid. The verification response, in some aspects, may indicate the results of a verification performed by the network node. While described for a valid verification request, in some aspects, the verification request may be invalid and the verification response will reflect the invalidity of the verification request and the fast link recovery procedure may be interrupted and/or terminated. For example, referring to FIG. 7, the CU 701 may transmit, a MAC-I result 716C (e.g., a MAC-I response) to one of the first DU 702 or the second DU 703, indicating the results of the verification at 716B.

In some aspects, the network entity may output, for at least one of the network node or the wireless device, an update to at least one parameter in the set of security parameters. In some aspects, the updated at least one parameter may for verifying (at the network node), and/or generating (at the wireless device) a subsequent L1 link recovery request or a subsequent L2 link recovery request. For example, referring to FIG. 7, the CU 701 may provide, for one or more of the first DU 702, the second DU 703, or the UE 704, at least one updated parameter in association with one of resuming the user plane communication at 720 and/or exchanging, and/or participating in, communication 722.

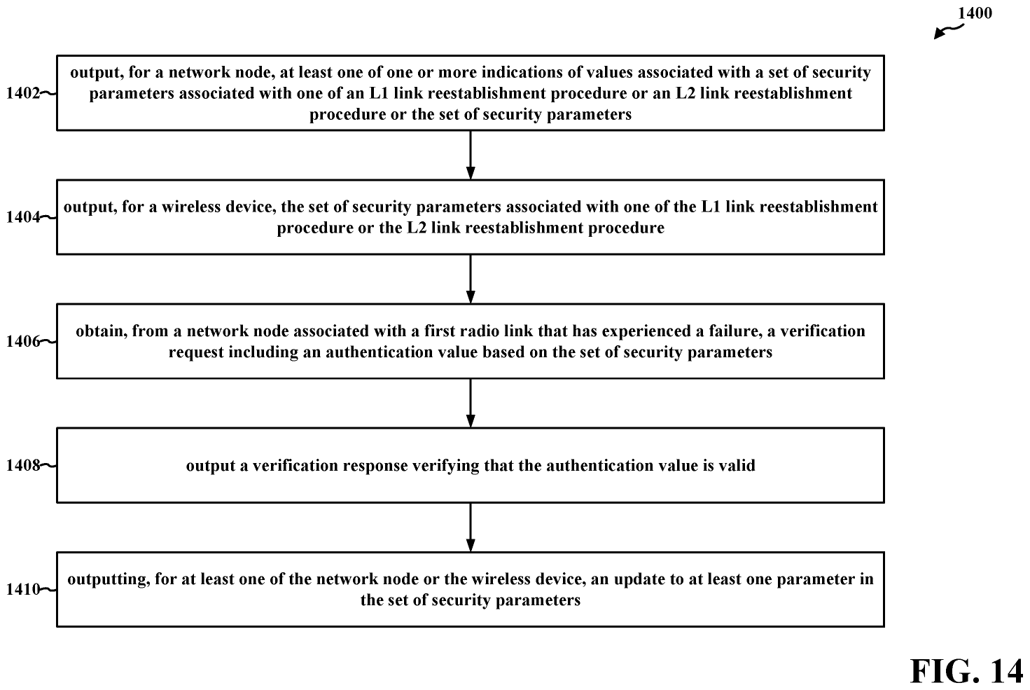

FIG. 14 is a flowchart 1400 of a method of wireless communication. The method may be performed by a network node that may be a CU of a base station or an element of a network entity (e.g., the base station 102; the CU 110, 701, 1610; the network entity 606; the network entity 1502, 1602, 1760). In some aspects, the network entity may be a CU associated with a plurality of DUs including at least one DU (e.g., a satellite-based DU in an NTN) that may be in communication with a wireless device (e.g., a UE) over a first radio link. In some aspects, the CU and one or more of the DUs (or a satellite associated with one or more of the DUs) in the plurality of DUs may be associated with a plurality of cells associated with the L1 link reestablishment procedure or the L2 link reestablishment procedure.

At 1402, the network node may output, for a network node, at least one of one or more indications of values associated with a set of security parameters associated with one of an L1 link reestablishment procedure or an L2 link reestablishment procedure or the set of security parameters. For example, 1402 may be performed by CU processor(s) 1612, transceiver(s) 1646, antenna(s) 1680, network processor 1712, network interface 1780, and/or fast link recovery for NTN component 199 of FIG. 16. The one or more indications output by the network entity, in some aspects may relate to one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. In some aspects, one or more of the above values may be omitted if the network node can independently verify requests associated with one of the L1 link reestablishment procedure or the L2 link reestablishment procedure. In some aspects, the L1 link reestablishment procedure or the L2 link reestablishment procedure reuses (is configured to reuse) L3 parameters associated with the first radio link. For example, referring to FIG. 7, the CU 701 may transmit, for the first DU 702 and or the second DU 703. DU L1/L2 recovery configuration messages 708 including the information for the fast link recovery procedure.

At 1404, the network entity may output, for a wireless device, the set of security parameters associated with one of the L1 link reestablishment procedure or the L2 link reestablishment procedure. For example, 1404 may be performed by CU processor(s) 1612, transceiver(s) 1646, antenna(s) 1680, network processor 1712, network interface 1780, and/or fast link recovery for NTN component 199 of FIG. 16. The set of security parameters, in some aspects, may include one or more of an ID of an associated wireless device, a C-RNTI, a TEID, at least one value used for a calculation of an authentication value (e.g., a MAC-I associated with one of the L1 link reestablishment procedure or the L2 link reestablishment procedure), a security algorithm associated with at least one of the L1 link reestablishment procedure or the L2 link reestablishment procedure, or a duration for which the set of security parameters is valid. As described for the one of one or more indications of values associated with the set of security parameters, in some aspects, one or more of the possible security parameters described above may be omitted if the network node can independently verify requests associated with one of the L1 link reestablishment procedure or the L2 link reestablishment procedure. For example, referring to FIG. 7, the CU 701 may transmit, and the UE 704 may receive, the UE L1/L2 recovery configuration messages 710 including the information for the fast link recovery procedure.

At 1406, the network entity may obtain, from a network node associated with a first radio link that has experienced a failure, a verification request including an authentication value based on the set of security parameters. For example, 1406 may be performed by CU processor(s) 1612, transceiver(s) 1646, antenna(s) 1680, network processor 1712, network interface 1780, and/or fast link recovery for NTN component 199 of FIG. 16. The authentication value, in some aspects, may be a MAC-I value to be compared to a MAC-I value calculated, and/or stored at, the network entity and the network entity may verify the authentication value by performing the comparison. For example, referring to FIG. 7, the CU 701 may receive, a MAC-I request 716A transmitted by one of the first DU 702 or the second DU 703, including the MAC-I value.

At 1408, the network entity may output, for the network node, a verification response verifying that the authentication value is valid. For example, 1408 may be performed by CU processor(s) 1612, transceiver(s) 1646, antenna(s) 1680, network processor 1712, network interface 1780, and/or fast link recovery for NTN component 199 of FIG. 16. The verification response, in some aspects, may indicate the results of a verification performed by the network node. While described for a valid verification request, in some aspects, the verification request may be invalid and the verification response will reflect the invalidity of the verification request and the fast link recovery procedure may be interrupted and/or terminated. For example, referring to FIG. 7, the CU 701 may transmit, a MAC-I result 716C (e.g., a MAC-I response) to one of the first DU 702 or the second DU 703, indicating the results of the verification at 716B.

At 1410, the network entity may output, for at least one of the network node or the wireless device, an update to at least one parameter in the set of security parameters. For example, 1410 may be performed by CU processor(s) 1612, transceiver(s) 1646, antenna(s) 1680, network processor 1712, network interface 1780, and/or fast link recovery for NTN component 199 of FIG. 16. In some aspects, the updated at least one parameter may for verifying (at the network node), and/or generating (at the wireless device) a subsequent L1 link recovery request or a subsequent L2 link recovery request. For example, referring to FIG. 7, the CU 701 may provide, for one or more of the first DU 702, the second DU 703, or the UE 704, at least one updated parameter in association with one of resuming the user plane communication at 720 and/or exchanging, and/or participating in, communication 722.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize one or more antennas 1580 for communication. The cellular baseband processor(s) 1524 communicates through the transceiver(s) 1522 via the one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the fast link recovery for NTN component 198 that may be configured to receive a set of security parameters associated with one of an L1 link reestablishment procedure or an L2 link reestablishment procedure, detect a failure of a radio link at the wireless device. The fast link recovery for NTN component 198 may further be configured to transmit, for a network node, at least one of an L1 link recovery request or an L2 link recovery request, where at least one of the L1 link recovery request or the L2 link recovery request includes an authentication value based on the set of security parameters, and receive, based on at least one of the L1 link recovery request or the L2 link recovery request, a link recovery message. The fast link recovery for NTN component 198 may be within the cellular baseband processor(s) 1524, the application processor(s) 1506, or both the cellular baseband processor(s) 1524 and the application processor(s) 1506. The fast link recovery for NTN component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a set of security parameters associated with one of an L1 link reestablishment procedure or an L2 link reestablishment procedure. The apparatus 1504, and in particular the cellular baseband processor(s) 1524 and/or the application processor(s) 1506, may further include means for detecting a failure of a radio link between the wireless device and a first network node. The apparatus 1504, and in particular the cellular baseband processor(s) 1524 and/or the application processor(s) 1506, may further include means for identifying a new cell to which to connect. The apparatus 1504, and in particular the cellular baseband processor(s) 1524 and/or the application processor(s) 1506, may further include means for determining that the new cell is associated with the network node. The apparatus 1504, and in particular the cellular baseband processor(s) 1524 and/or the application processor(s) 1506, may further include means for receiving an indication of the set of cells configured for at least one of the L1 link reestablishment procedure or the L2 link reestablishment procedure. The apparatus 1504, and in particular the cellular baseband processor(s) 1524 and/or the application processor(s) 1506, may further include means for transmitting, for a network node, at least one of an L1 link recovery request or an L2 link recovery request, where at least one of the L1 link recovery request or the L2 link recovery request includes an authentication value based on the set of security parameters. The apparatus 1504, and in particular the cellular baseband processor(s) 1524 and/or the application processor(s) 1506, may further include means for receiving, based on at least one of the L1 link recovery request or the L2 link recovery request, a link recovery message. The apparatus 1504, and in particular the cellular baseband processor(s) 1524 and/or the application processor(s) 1506, may further include means for receiving an update to at least one parameter in the set of security parameters. The apparatus 1504, and in particular the cellular baseband processor(s) 1524 and/or the application processor(s) 1506, may further include means for updating the at least one parameter in the set of security parameters. The means may be the fast link recovery for NTN component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means or as described in relation to FIGS. 9 and 10.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the fast link recovery for NTN component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, one or more antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the fast link recovery for NTN component 199 that may be configured to transmit, for a wireless device, a set of security parameters associated with one of an L1 link reestablishment procedure or an L2 link reestablishment procedure. The fast link recovery for NTN component 199 may further be configured to receive, from the wireless device experiencing a failure of a first radio link, at least one of an L1 link recovery request or an L2 link recovery request, where at least one the L1 link recovery request or the L2 link recovery request includes an authentication value based on the set of security parameters, and transmit, for the wireless device, a link recovery message associated with a reestablishment of a second radio link. The fast link recovery for NTN component 199 may be within one or more processors of one or more of the CU 1610, DU 1630, and the RU 1640. The fast link recovery for NTN component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, for a wireless device, a set of security parameters associated with one of an L1 link reestablishment procedure or an L2 link reestablishment procedure. The network entity 1602, in some aspects, may include means for receiving, from the wireless device experiencing a failure of a first radio link, at least one of an L1 link recovery request or an L2 link recovery request, where at least one of the L1 link recovery request or the L2 link recovery request includes an authentication value based on the set of security parameters. The network entity 1602, in some aspects, may include means for verifying, based on the authentication value, that at least one of the L1 link recovery request or the L2 link recovery request is valid. The network entity 1602, in some aspects, may include means for determining that the authentication value included in at least one of the L1 link recovery request or the L2 link recovery request matches a locally-stored authentication value. The network entity 1602, in some aspects, may include means for transmitting, for a network entity associated with the first radio link, a verification request including the authentication value. The network entity 1602, in some aspects, may include means for receiving a verification response verifying that the authentication value is valid. The network entity 1602, in some aspects, may include means for transmitting, for the wireless device, a link recovery message associated with a reestablishment of a second radio link. The network entity 1602, in some aspects, may include means for receiving, from a network entity, the update to the at least one parameter in the set of security parameters. The network entity 1602, in some aspects, may include means for transmitting, for the wireless device, an update to at least one parameter in the set of security parameters. The network entity 1602, in some aspects, may include means for receiving, from a network entity, one or more indications of values associated with the set of security parameters. The network entity 1602, in some aspects, may include means for generating, before the transmission of the set of security parameters and based on the one or more indications, the set of security parameters. The means may be the fast link recovery for NTN component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 11 and 12.

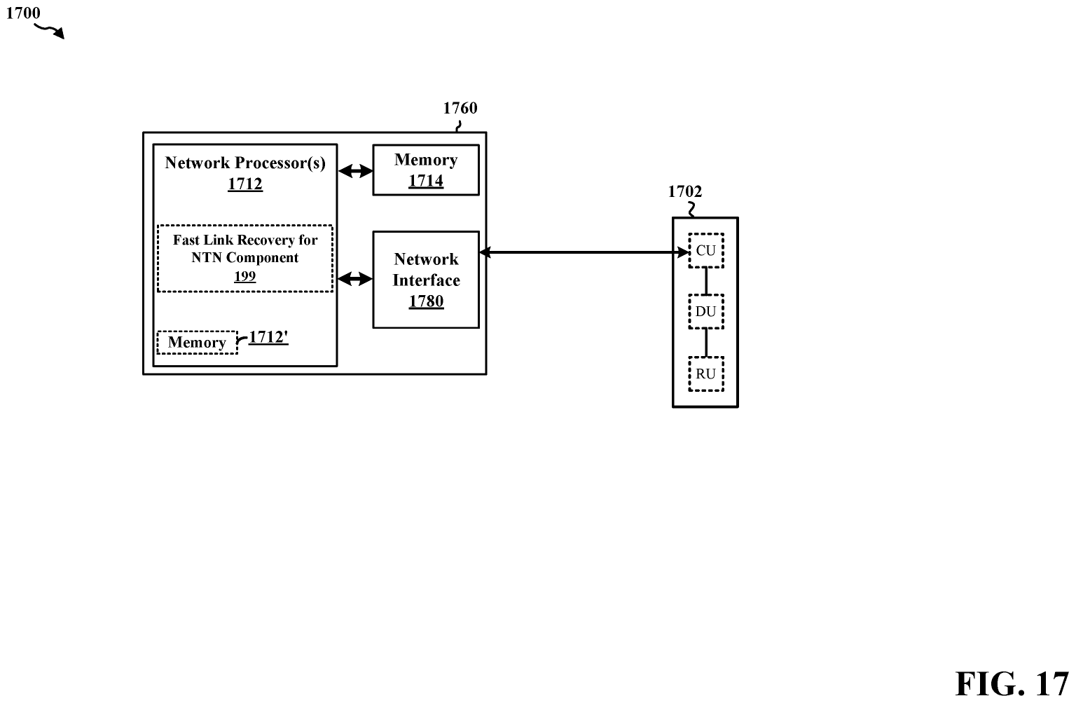

FIG. 17 is a diagram 1700 illustrating an example of a hardware implementation for a network entity 1760. In one example, the network entity 1760 may be within the core network 120. The network entity 1760 may include at least one network processor 1712. The network processor(s) 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The network processor(s) 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the fast link recovery for NTN component 199 that may be configured to output, for a network node, at least one of one or more indications of values associated with a set of security parameters associated with one of an L1 link reestablishment procedure or an L2 link reestablishment procedure or the set of security parameters and output, for a wireless device, the set of security parameters associated with one of the L1 link reestablishment procedure or the L2 link reestablishment procedure. The fast link recovery for NTN component 199 may be within the network processor(s) 1712. The fast link recovery for NTN component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1760 may include a variety of components configured for various functions. In one configuration, the network entity 1760 may include means for outputting, for a network node, at least one of one or more indications of values associated with a set of security parameters associated with one of an L1 link reestablishment procedure or an L2 link reestablishment procedure or the set of security parameters. The network entity 1760, in some aspects, may include means for outputting, for a wireless device, the set of security parameters associated with one of the L1 link reestablishment procedure or the L2 link reestablishment procedure. The network entity 1760, in some aspects, may include means for obtaining, from a network node associated with a first radio link that has experienced a failure, a verification request including an authentication value based on the set of security parameters. The network entity 1760, in some aspects, may include means for outputting a verification response verifying that the authentication value is valid. The network entity 1760, in some aspects, may include means for outputting, for at least one of the network node or the wireless device, an update to at least one parameter in the set of security parameters. The means may be the fast link recovery for NTN component 199 of the network entity 1760 configured to perform the functions recited by the means or as described in relation to FIGS. 13 and 14.

In some aspects of wireless communication, a cell associated with an NTN cell (e.g., associated with a satellite-based base station and/or DU) may cover a (very) wide area and may be easily blocked, e.g., by buildings, tunnels, or other obstacles. Based on the wide coverage that is easily blocked, even if the UE temporarily loses contact with an NTN cell serving the UE, it may be likely that the UE will identify the same NTN cell again after passing through a blocked area. In some aspects, the UE may initiate a radio resource control (RRC) reestablishment procedure to connect to the same NTN cell. Because the RRC reestablishment procedure, in some aspects, includes RRC-level interaction (e.g., layer 3 (L3) communication) between the UE and a CU via the satellite-based base station and/or DU, the reestablishment procedure may involve long delays associated with transmissions to and from the satellite-based base station and/or DU. For example, the reestablishment procedure may, due to a radio link control (RLC) flush (e.g., a reset of RLC parameters), involve control plane signaling and user plane retransmissions associated with a packet data convergence protocol (PDCP) due

Various aspects relate generally to a novel link reestablishment for reestablishing a link with a same DU or, in some aspects, for establishing a link with a DU associated with a same CU that avoids resetting layer 3 parameters. The novel link reestablishment procedure, in some aspects, may reduce a link reestablishment time compared to an RRC reestablishment procedure associated with configuring L3 parameters, where the reduction may be larger for NTNs than for terrestrial networks. Some aspects more specifically relate to providing configuration information that may be used to enable a link reestablishment procedure that avoids configuring L3 parameters. Particular aspects of the subject matter described in this disclosure can be implemented to realize one or more of the following potential advantages. In some examples, by using the novel L1 link reestablishment procedure and/or the L2 link reestablishment procedure, the described techniques can be used to reduce a latency associated with link reestablishment and/or recovery, especially associated with an NTN.

In an NTN, a UE may frequently lose connectivity with a satellite due to buildings, tunnels, or other obstructions. According to current procedures, a UE attempts RRC connection reestablishment with the same cell. In case of split DU-CU architecture with DU being in the satellite, this may take a very long time. After an RLF, when a UE attempts connection establishment again to the same cell (or DU), it may attempt to re-establish the connection with gNB-DU (not involving gNB-CU) using the fast link recovery process according to some aspects of the disclosure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication for a wireless device, comprising: receiving a set of security parameters associated with one of a layer 1 (L1) link reestablishment procedure or a layer 2 (L2) link reestablishment procedure; detecting a failure of a radio link between the wireless device and a first network node; transmitting, for a network node configured for at least one of the L1 link reestablishment procedure or the L2 link reestablishment procedure, an authentication value based on the set of security parameters included in at least one of an L1 link recovery request or an L2 link recovery request; and receiving, based on at least one of the L1 link recovery request or the L2 link recovery request, a link recovery message.

Aspect 2 is the method of aspect 1, wherein the set of security parameters comprises one or more of a first identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid.

Aspect 3 is the method of aspect 2, wherein the authentication value comprises a message authentication code for integrity (MAC-I) value, and the L1 link recovery request or the L2 link recovery request comprises one or more of the ID of the wireless device, the C-RNTI, the TEID, the MAC-I value, a cause value indicating a type of failure associated with the failure of the radio link, a second ID of the first network node, or a third ID of a network entity associated with the first network node, and wherein the network entity comprises a centralized unit (CU).

Aspect 4 is the method of any of aspects 1 to 3, wherein the radio link is a first radio link with a first cell associated with the first network node, the method further comprising: identifying a new cell to which to connect, wherein the new cell is one of the first cell or a second cell associated with the network node configured for at least one of the L1 link reestablishment procedure or the L2 link reestablishment procedure; and determining that the new cell is configured for one of the L1 link reestablishment procedure or the L2 link reestablishment procedure, wherein transmitting at least one of the L1 link recovery request or the L2 link recovery request comprises transmitting at least one of the L1 link recovery request or the L2 link recovery request for the new cell based on the determination that the new cell is configured for one of the L1 link reestablishment procedure or the L2 link reestablishment procedure.

Aspect 5 is the method of aspect 4, wherein the first network node comprises a first satellite-based distributed unit (DU) associated with a first satellite in a non-terrestrial network (NTN), wherein the wireless device is a user equipment (UE), and wherein determining that the new cell is configured for at least one of the L1 link reestablishment procedure or the L2 link reestablishment procedure comprises determining one of (1) that the new cell is associated with the first satellite, (2) that the new cell is associated with the first satellite-based DU, or (3) that the new cell belongs to a set of cells configured for at least one of the L1 link reestablishment procedure or the L2 link reestablishment procedure, wherein the set of cells comprises at least one cell associated with an additional DU.

Aspect 6 is the method of aspect 5, wherein at least one of (1) the determination that the new cell is associated with the first satellite is based on an ID of the first satellite associated with the first cell and associated with the new cell, (2) the determination that the new cell is associated with the first satellite-based DU is based on a DU ID included in one of a system information or a dedicated indication, or (3) the method further comprises: receiving an indication of the set of cells configured for at least one of the L1 link reestablishment procedure or the L2 link reestablishment procedure.

Aspect 7 is the method of any of aspects 1 to 6, wherein the L1 link reestablishment procedure or the L2 link reestablishment procedure reuses layer 3 (L3) parameters associated with the radio link.

Aspect 8 is the method of any of the aspects 1 to 7, wherein after the reception of the link recovery message, the method further comprises one of: receiving an update to at least one parameter in the set of security parameters; or updating the at least one parameter in the set of security parameters, wherein the at least one parameter in the set of security parameters is updated for a calculation of a different authentication value to be used for a subsequent L1 link recovery request or a subsequent L2 link recovery request.

Aspect 9 is the method of any of aspects 1 to 8, wherein the L1 link recovery request or the L2 link recovery request is associated with one or more of a radio link control (RLC) layer, a medium access control (MAC) layer, or a physical (PHY) layer.

Aspect 10 is a method for wireless communication for a network node, comprising: transmitting, for a wireless device, a set of security parameters associated with one of a layer 1 (L1) link reestablishment procedure or a layer 2 (L2) link reestablishment procedure; receiving, from the wireless device experiencing a failure of a first radio link, at least one of an L1 link recovery request or an L2 link recovery request, wherein at least one the L1 link recovery request or the L2 link recovery request includes an authentication value based on the set of security parameters; and transmitting, for the wireless device, a link recovery message associated with a reestablishment of a second radio link.

Aspect 11 is the method of aspect 10, further comprising: verifying, based on the authentication value, that at least one of the L1 link recovery request or the L2 link recovery request is valid, wherein transmitting the link recovery message is based on the verification that at least one of the L1 link recovery request or the L2 link recovery request is valid.

Aspect 12 is the method of aspect 11, wherein verifying that at least one of the L1 link recovery request or the L2 link recovery request is valid comprises determining that the authentication value included in at least one of the L1 link recovery request or the L2 link recovery request matches a locally-stored authentication value.

Aspect 13 is the method of aspect 11, wherein verifying that at least one of the L1 link recovery request or the L2 link recovery request is valid comprises: transmitting, for a network entity associated with the first radio link, a verification request including the authentication value; and receiving a verification response verifying that the authentication value is valid.

Aspect 14 is the method any of the aspects 10 to 13, wherein the set of security parameters comprises one or more of a first identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid.

Aspect 15 is the method of aspect 14, wherein the network node comprises a satellite-based distributed unit (DU) associated with a first satellite in a non-terrestrial network (NTN), wherein the wireless device is a user equipment (UE), and wherein at least one of the first satellite or the DU is associated with a plurality of cells associated with the L1 link reestablishment procedure or the L2 link reestablishment procedure.

Aspect 16 is the method of aspect 15, wherein the first radio link is associated with a first cell of the plurality of cells and at least one of the L1 link recovery request or the L2 link recovery request is associated with a second cell of the plurality of cells.

Aspect 17 is the method of any of aspects 14 to 16, wherein the authentication value comprises a message authentication code for integrity (MAC-I) value, and the L1 link recovery request or the L2 link recovery request comprises one or more of the first ID of the wireless device, the C-RNTI, the TEID, the MAC-I value, a cause value indicating a type of failure associated with the failure of the first radio link, a second ID of the network node, or a third ID of a network entity associated with the network node.

Aspect 18 is the method of any of the aspects 10 to 17, wherein the L1 link reestablishment procedure or the L2 link reestablishment procedure reuses layer 3 (L3) parameters associated with the first radio link.

Aspect 19 is the method of any of aspects 10 to 18, wherein after the transmission of the link recovery message, the method further comprising: transmitting, for the wireless device, an update to at least one parameter in the set of security parameters, wherein the at least one parameter in the set of security parameters is updated for a calculation of a different authentication value to be used for a subsequent L1 link recovery request or a subsequent L2 link recovery request.

Aspect 20 is the method of aspect 19, the method further comprising: receiving, from a network entity, the update to the at least one parameter in the set of security parameters.

Aspect 21 is the method of any of the aspects 10 to 20, wherein the L1 link recovery request or the L2 link recovery request is associated with one or more of a radio link control (RLC) layer, a medium access control (MAC) layer, or a physical (PHY) layer.

Aspect 22 is the method of any of the aspects 10 to 21, further comprising: receiving, from a network entity, one or more indications of values associated with the set of security parameters; and generating, before the transmission of the set of security parameters and based on the one or more indications, the set of security parameters.

Aspect 23 is a method for wireless communication for a network entity, comprising: outputting, for a network node, at least one of one or more indications of values associated with a set of security parameters associated with one of a layer 1 (L1) link reestablishment procedure or a layer 2 (L2) link reestablishment procedure or the set of security parameters; and outputting, for a wireless device, the set of security parameters associated with one of the L1 link reestablishment procedure or the L2 link reestablishment procedure.

Aspect 24 is the method of aspect 23, further comprising: obtaining, from a network node associated with a first radio link that has experienced a failure, a verification request including an authentication value based on the set of security parameters; and outputting a verification response verifying that the authentication value is valid.

Aspect 25 is the method of aspect 24, wherein the set of security parameters comprises one or more of an identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, a security algorithm associated with at least one of the L1 link reestablishment procedure or the L2 link reestablishment procedure, or a duration for which the set of security parameters is valid.

Aspect 26 is the method of aspect 25, wherein the network node comprises a satellite-based distributed unit (DU) associated with a first satellite in a non-terrestrial network (NTN), wherein the wireless device is a user equipment (UE), and wherein at least one of the first satellite or the DU is associated with a plurality of cells associated with the L1 link reestablishment procedure or the L2 link reestablishment procedure.

Aspect 27 is the method of aspect 26, wherein the first radio link is associated with a first cell of the plurality of cells and the verification request is associated with a second cell of the plurality of cells.

Aspect 28 is the method of any of the aspects 24 to 28, wherein after the obtainment of the verification request, the method further comprising: outputting, for at least one of the network node or the wireless device, an update to at least one parameter in the set of security parameters, wherein the at least one parameter in the set of security parameters is updated for a calculation of a different authentication value to be used in association with a subsequent verification request.

Aspect 29 is the method of any of the aspects 23 to 27, wherein the L1 link reestablishment procedure or the L2 link reestablishment procedure reuses layer 3 (L3) parameters associated with a radio link for which failure was detected.

Aspect 30 is the method of any of the aspects 23 to 30, wherein the L1 link reestablishment procedure or the L2 link reestablishment procedure is associated with one or more of a radio link control (RLC) layer, a medium access control (MAC) layer, or a physical (PHY) layer.

Aspect 31 is an apparatus for wireless communication at a device including a memory and at least one processor coupled to the memory and, based at least in part on information stored in the memory, the at least one processor is configured to implement any of aspects 1 to 9.

Aspect 32 is the apparatus of aspect 31, further including a transceiver or an antenna coupled to the at least one processor.

Aspect 33 is an apparatus for wireless communication at a device including means for implementing any of aspects 1 to 9.

Aspect 34 is a computer-readable medium (e.g., a non-transitory computer-readable medium) storing computer executable code, where the code when executed by a processor causes the processor to implement any of aspects 1 to 9.

Aspect 35 is an apparatus for wireless communication at a device including a memory and at least one processor coupled to the memory and, based at least in part on information stored in the memory, the at least one processor is configured to implement any of aspects 10 to 22.

Aspect 36 is the apparatus of aspect 35, further including a transceiver or an antenna coupled to the at least one processor.

Aspect 37 is an apparatus for wireless communication at a device including means for implementing any of aspects 10 to 22.

Aspect 38 is a computer-readable medium (e.g., a non-transitory computer-readable medium) storing computer executable code, where the code when executed by a processor causes the processor to implement any of aspects 10 to 22.

Aspect 39 is an apparatus for wireless communication at a device including a memory and at least one processor coupled to the memory and, based at least in part on information stored in the memory, the at least one processor is configured to implement any of aspects 23 to 30.

Aspect 40 is the apparatus of aspect 39, further including a transceiver or an antenna coupled to the at least one processor.

Aspect 41 is an apparatus for wireless communication at a device including means for implementing any of aspects 23 to 30.

Aspect 42 is a computer-readable medium (e.g., a non-transitory computer-readable medium) storing computer executable code, where the code when executed by a processor causes the processor to implement any of aspects 23 to 30.

What is claimed is:

1. An apparatus for wireless communication at a wireless device, comprising:
at least one memory; and
at least one processor coupled to the at least one memory and, based at least in part on stored information that is stored in the at least one memory, the at least one processor, individually or in any combination, is configured to:
receive a set of security parameters associated with one of a layer 1 (L1) link reestablishment procedure or a layer 2 (L2) link reestablishment procedure;
detect a failure of a radio link between the wireless device and a first network node;
transmit, for a network node configured for at least one of the L1 link reestablishment procedure or the L2 link reestablishment procedure and based on the set of security parameters, an authentication value included in at least one of an L1 link recovery request or an L2 link recovery request; and
receive, based on at least one of the L1 link recovery request or the L2 link recovery request, a link recovery message.

2. The apparatus of claim 1, wherein the set of security parameters comprises one or more of a first identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid.

3. The apparatus of claim 2, wherein the authentication value comprises a message authentication code for integrity (MAC-I) value, and the L1 link recovery request or the L2 link recovery request comprises one or more of the ID of the wireless device, the C-RNTI, the TEID, the MAC-I value, a cause value indicating a type of failure associated with the failure of the radio link, a second ID of the first network node, or a third ID of a network entity associated with the first network node, and wherein the network entity comprises a centralized unit (CU).

4. The apparatus of claim 1, wherein the radio link is a first radio link with a first cell associated with the first network node, wherein the at least one processor, individually or in any combination, is further configured to:
identify a new cell to which to connect, wherein the new cell is one of the first cell or a second cell associated with the network node configured for at least one of the L1 link reestablishment procedure or the L2 link reestablishment procedure; and
determine that the new cell is configured for one of the L1 link reestablishment procedure or the L2 link reestablishment procedure, wherein to transmit the authentication value included in at least one of the L1 link recovery request or the L2 link recovery request, the at least one processor, individually or in any combination, is configured to transmit the authentication value included in at least one of the L1 link recovery request or the L2 link recovery request for the new cell based on the determination that the new cell is configured for one of the L1 link reestablishment procedure or the L2 link reestablishment procedure.

5. The apparatus of claim 4, wherein the first network node comprises a first satellite-based distributed unit (DU) associated with a first satellite in a non-terrestrial network (NTN), wherein the wireless device is a user equipment (UE), and wherein to determine that the new cell is configured for at least one of the L1 link reestablishment procedure or the L2 link reestablishment procedure, the at least one processor, individually or in any combination, is configured to determine one of (1) that the new cell is associated with the first satellite, (2) that the new cell is associated with the first satellite-based DU, or (3) that the new cell belongs to a set of cells configured for at least one of the L1 link reestablishment procedure or the L2 link reestablishment procedure, wherein the set of cells comprises at least one cell associated with an additional DU.

6. The apparatus of claim 5, wherein the at least one processor, individually or in any combination, is configured to at least one of (1) determine that the new cell is associated with the first satellite based on an ID of the first satellite associated with the first cell and associated with the new cell, (2) determine that the new cell is associated with the first satellite-based DU based on a DU ID included in one of a system information or a dedicated indication, or (3) the at least one processor, individually or in any combination, is further configured to:
receive an indication of the set of cells configured for at least one of the L1 link reestablishment procedure or the L2 link reestablishment procedure.

7. The apparatus of claim 1, wherein the L1 link reestablishment procedure or the L2 link reestablishment procedure reuses layer 3 (L3) parameters associated with the radio link.

8. The apparatus of claim 1, wherein the at least one processor, individually or in any combination, is configured, after a reception of the link recovery message, to:
receive an update to at least one parameter in the set of security parameters; or
update the at least one parameter in the set of security parameters, wherein to update the at least one parameter, the at least one processor, individually or in any combination, is configured to update the at least one parameter in the set of security parameters for a calculation of a different authentication value to be used for a subsequent L1 link recovery request or a subsequent L2 link recovery request.

9. The apparatus of claim 1, further comprising at least one of a transceiver or an antenna coupled to the at least one processor, wherein to receive the link recovery message, the at least one processor is configured to receive, via at least one of the transceiver or the antenna, the link recovery message, and wherein the L1 link recovery request or the L2 link recovery request is associated with one or more of a radio link control (RLC) layer, a medium access control (MAC) layer, or a physical (PHY) layer.

10. An apparatus for wireless communication for a network node, comprising:
at least one memory; and
at least one processor coupled to the at least one memory and, based at least in part on stored information that is stored in the at least one memory, the at least one processor, individually or in any combination, is configured to:
transmit, for a wireless device, a set of security parameters associated with one of a layer 1 (L1) link reestablishment procedure or a layer 2 (L2) link reestablishment procedure;
receive, from the wireless device experiencing a failure of a first radio link, at least one of an L1 link recovery request or an L2 link recovery request, wherein at least one the L1 link recovery request or the L2 link recovery request includes an authentication value based on the set of security parameters; and
transmit, for the wireless device, a link recovery message associated with a reestablishment of a second radio link.

11. The apparatus of claim 10, wherein the at least one processor, individually or in any combination, is further configured to:
verify, based on the authentication value, that at least one of the L1 link recovery request or the L2 link recovery request is valid, wherein to transmit the link recovery message, the at least one processor, individually or in any combination, is configured to transmit the link recovery message based on the verification that at least one of the L1 link recovery request or the L2 link recovery request is valid.

12. The apparatus of claim 11, wherein to verify that at least one of the L1 link recovery request or the L2 link recovery request is valid, the at least one processor, individually or in any combination, is configured to determine that the authentication value included in at least one of the L1 link recovery request or the L2 link recovery request matches a locally-stored authentication value.

13. The apparatus of claim 11, wherein to verify that at least one of the L1 link recovery request or the L2 link recovery request is valid, the at least one processor, individually or in any combination, is configured to:
transmit, for a network entity associated with the first radio link, a verification request including the authentication value; and
receive a verification response verifying that the authentication value is valid.

14. The apparatus of claim 10, wherein the set of security parameters comprises one or more of an identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid.

15. The apparatus of claim 14, wherein the network node comprises a satellite-based distributed unit (DU) associated with a first satellite in a non-terrestrial network (NTN), wherein the wireless device is a user equipment (UE), and wherein at least one of the first satellite or the DU is associated with a plurality of cells associated with the L1 link reestablishment procedure or the L2 link reestablishment procedure.

16. The apparatus of claim 15, wherein the first radio link is associated with a first cell of the plurality of cells and at least one of the L1 link recovery request or the L2 link recovery request is associated with a second cell of the plurality of cells.

17. The apparatus of claim 14, wherein the authentication value comprises a message authentication code for integrity (MAC-I) value, and the L1 link recovery request or the L2 link recovery request comprises one or more of the ID of the wireless device, the C-RNTI, the TEID, the MAC-I value, a cause value indicating a type of failure associated with the failure of the first radio link, an ID of the network node, or an identify of a network entity associated with the network node.

18. The apparatus of claim 10, wherein the L1 link reestablishment procedure or the L2 link reestablishment procedure reuses layer 3 (L3) parameters associated with the first radio link.

19. The apparatus of claim 10, wherein the at least one processor, individually or in any combination, is further configured to:
transmit, for the wireless device and after a transmission of the link recovery message, an update to at least one parameter in the set of security parameters, wherein to update the at least one parameter, the at least one processor, individually or in any combination, is configured to update the at least one parameter in the set of security parameters for a calculation of a different authentication value to be used for a subsequent L1 link recovery request or a subsequent L2 link recovery request.

20. The apparatus of claim 19, wherein the at least one processor, individually or in any combination, is further configured to:
receive, from a network entity, the update to the at least one parameter in the set of security parameters.

21. The apparatus of claim 10, further comprising at least one of a transceiver or an antenna coupled to the at least one processor, wherein to transmit the link recovery message, the at least one processor is configured to transmit, via at least one of the transceiver or the antenna, the link recovery message, and wherein the L1 link recovery request or the L2 link recovery request is associated with one or more of a radio link control (RLC) layer, a medium access control (MAC) layer, or a physical (PHY) layer.

22. The apparatus of claim 10, wherein the at least one processor, individually or in any combination, is further configured to:
receive, from a network entity, one or more indications of values associated with the set of security parameters; and
generate, before a transmission of the set of security parameters and based on the one or more indications, the set of security parameters.

23. A method for wireless communication for a wireless device, comprising:
receiving a set of security parameters associated with one of a layer 1 (L1) link reestablishment procedure or a layer 2 (L2) link reestablishment procedure;
detecting a failure of a radio link between the wireless device and a first network node;
transmitting, for a network node configured for at least one of the L1 link reestablishment procedure or the L2 link reestablishment procedure and based on the set of security parameters, an authentication value included in at least one of an L1 link recovery request or an L2 link recovery request; and
receiving, based on at least one of the L1 link recovery request or the L2 link recovery request, a link recovery message.

24. The method of claim 23, wherein the set of security parameters comprises one or more of a first identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid, and wherein the authentication value comprises a message authentication code for integrity (MAC-I) value, and the L1 link recovery request or the L2 link recovery request comprises one or more of the first ID of the wireless device, the C-RNTI, the TEID, the MAC-I value, a cause value indicating a type of failure associated with the failure of the radio link, a second ID of the first network node, or a third ID of a network entity associated with the first network node, and wherein the network entity comprises a centralized unit (CU).

25. The method of claim 23, wherein the radio link is a first radio link with a first cell associated with the first network node, the method further comprising:
identifying a new cell to which to connect, wherein the new cell is one of the first cell or a second cell associated with the network node configured for at least one of the L1 link reestablishment procedure or the L2 link reestablishment procedure; and
determining that the new cell is configured for one of the L1 link reestablishment procedure or the L2 link reestablishment procedure, wherein transmitting the authentication value included in at least one of the L1 link recovery request or the L2 link recovery request comprises transmitting at least one of the L1 link recovery request or the L2 link recovery request for the new cell based on the determination that the new cell is configured for one of the L1 link reestablishment procedure or the L2 link reestablishment procedure.

26. The method of claim 25, wherein the first network node comprises a first satellite-based distributed unit (DU) associated with a first satellite in a non-terrestrial network (NTN), wherein the wireless device is a user equipment (UE), and wherein determining that the new cell is configured for at least one of the L1 link reestablishment procedure or the L2 link reestablishment procedure comprises determining one of (1) that the new cell is associated with the first satellite, (2) that the new cell is associated with the first satellite-based DU, or (3) that the new cell belongs to a set of cells configured for at least one of the L1 link reestablishment procedure or the L2 link reestablishment procedure, wherein the set of cells comprises at least one cell associated with an additional DU.

27. A method for wireless communication for a network node, comprising:
transmitting, for a wireless device, a set of security parameters associated with one of a layer 1 (L1) link reestablishment procedure or a layer 2 (L2) link reestablishment procedure;
receiving, from the wireless device experiencing a failure of a first radio link, at least one of an L1 link recovery request or an L2 link recovery request, wherein at least one the L1 link recovery request or the L2 link recovery request includes an authentication value based on the set of security parameters; and
transmitting, for the wireless device, a link recovery message associated with a reestablishment of a second radio link.

28. The method of claim 27, further comprising:
verifying, based on the authentication value, that at least one of the L1 link recovery request or the L2 link recovery request is valid, wherein transmitting the link recovery message is based on the verification that at least one of the L1 link recovery request or the L2 link recovery request is valid.

29. The method of claim 28, wherein verifying that at least one of the L1 link recovery request or the L2 link recovery request is valid comprises one of:
determining that the authentication value included in at least one of the L1 link recovery request or the L2 link recovery request matches a locally-stored authentication value; or
transmitting, for a network entity associated with the first radio link, a verification request including the authentication value; and
receiving a verification response verifying that the authentication value is valid.

30. The method of claim 27, wherein the set of security parameters comprises one or more of a first identifier (ID) of the wireless device, a cell radio network temporary ID (C-RNTI), a tunnel endpoint ID (TEID), at least one value used for a calculation of the authentication value, a security algorithm associated with at least one of the L1 link reestablishment procedure or the L2 link reestablishment procedure, or a duration for which the set of security parameters is valid, and wherein the authentication value comprises a message authentication code for integrity (MAC-I) value, and the L1 link recovery request or the L2 link recovery request comprises one or more of the first ID of the wireless device, the C-RNTI, the TEID, the MAC-I value, a cause value indicating a type of failure associated with the failure of the first radio link, a second ID of the network node, or a third ID of a network entity associated with the network node.
